(19) United States
(12) Patent Application Publication
(10) Pub. No.: US 2009/0140136 A1
(43) Pub. Date: Jun. 4, 2009

(54) Method Of Analyzing Protein

(75) Inventors: Hiroaki Torii, Tokyo (JP); Kenji Miyazaki, Tokyo (JP); Kenichi Kamijo, Tokyo (JP); Akira Tsugita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 11/547,516

(22) PCT Filed: Feb. 8, 2005
(86) PCT No.: PCT/JP2005/001849

§ 371 Date: Oct. 2, 2006

(30) Foreign Application Priority Data
Mar. 30, 2004 (JP) 2004-101198

(51) Int. Cl. B01D 59/44

(52) U.S. Cl. 250/282

(57) ABSTRACT

The primary structure or the modification state of a protein is analyzed in detail. First, an analyte protein is subjected to PMF analysis (S101), and the gene of the protein is identified. Unidentified peaks not corresponding to the peaks of hypothetical peptide fragments are extracted, by comparing the hypothetical mass spectrum with the mass spectrum obtained by mass spectrometry of a sample protein (S102). Then, the unidentified peaks obtained are analyzed, and thus, the structure or properties of the protein, the presence and the kind of modification of amino acid residues, amino acid substitution, generation of mutants, and terminal cleavage are analyzed (S103).

### TECHNICAL FIELD

The present invention relates to a method of analyzing proteins.

### BACKGROUND ART

Proteome analysis, which obtains information on the expression and the properties of all proteins contained in cell cyclopaedically, is attracting attention recently. The method of identifying a protein commonly used in the proteome analysis is peptide mass fingerprint (PMF) method (Non-patent Document 1). In the PMF method, a protein separated and purified, for example, by two-dimensional electrophoresis is decomposed enzymatically, and the digested fragment peptides are analyzed by mass spectrometry. And, the candidates for the gene and protein associated with the sample protein are identified, by comparing the spectrum obtained by mass spectrometry with the theoretical peak pattern predicted from the information on the amino acid sequence of known proteins stored, for example, in database.

Non-patent Document 1: Wenzhu Zhang, Brian T. Chait, “ProFound: An Expert System for Protein Identification Using Mass Spectrometric Peptide Mapping Information”, 2000, Analytical Chemistry, 72nd volume, p. 2482-2489

### DISCLOSURE OF THE INVENTION

However, proteins expressed actually in the body often have a primary structure and a modified state different from those of the proteins predicted from known or gene information, because of modifications such as post-translational modification, change in amino acid sequence or change in splicing pattern. Thus, conventional methods of comparing with the fragment peaks derived from the amino acid sequences of known proteins or proteins predicted from gene still has room for improvement in terms of satisfactory, for more detailed analysis of sample protein.

An object of the present invention, which was made under the circumstance above, is to provide a technique of analyzing the primary structure or the modification state of proteins in detail.

In the conventional PMF method, all of the peaks in the mass spectrum of the sample protein are not identified in comparison with theoretical peak patterns. Such peaks unidentified are called “unidentified peaks” in the present invention. Among the peptide fragments, the presence of which is predicted from the amino acid sequence described in database, not all fragments are detected. Such peptide fragments not detected are called “undetected peptide” in the present invention. Because detection of all fragments is not needed for identification of the gene associated with a sample protein, the information on the peaks remaining unidentified has been discarded without use after identification of gene conventionally.

Major causes for generation of such unidentified peaks and undetected peptides include presence of peptide fragments having an amino acid sequence different from that described in database, generation of peptide fragments having a mass different from the fragments predicted, for example, by post-translational modification, difference in splicing pattern, and the like.

The inventors have considered that the peaks unidentified in the conventional PMF method have contained such information. Based on the belief that it is possible to obtain information inherent to the proteins actually expressed in the body by analyzing hitherto peaks to be identified, the inventors completed after intensive studies the present invention.

The genes identified in the conventional PMF method by using part of the peaks present in the mass spectrum of sample protein will be called “hypothetical genes” in the present invention. The amino acid sequence of the protein predicted by the hypothetical gene will be called “hypothetical amino acid sequence”. And, the peptide fragment predicted to be generated by site-selective fragmentation of protein on the basis of on the hypothetical amino acid sequence will be called “hypothetical peptide fragment”. Further, the mass spectrum predicted to be obtained from the hypothetical peptide fragment will be called “hypothetical mass spectrum”.

In the present invention, the term “identification” means to make the identity of a peak clear scientifically in mass spectrometric analysis. Alternatively, the term “detection” means that a peak corresponding to a hypothetical peptide fragment predicted from its hypothetical gene is observed in a mass spectrum measured.

Also in the present invention, the “unidentified peak” described above is a peak not corresponding to the peaks present in the hypothetical mass spectrum, among the peaks in the mass spectrum of an analyte protein. The “undetected peptide” is a peptide fragment corresponding to the peaks absent in the mass spectrum of analyte protein, among the peaks present in the hypothetical mass spectrum.

According to the present invention, there is provided a method of analyzing a peptide, including cleaving an analyte protein at a predetermined site selectively and obtaining the mass spectrum of the peptide fragments generated, identifying the gene corresponding to the protein by using the peaks contained in the mass spectrum, and analyzing at least one of the following analyses (i) to (iv) by using unidentified peaks not corresponding to the hypothetical peaks, among the peaks, present in the hypothetical mass spectra of the hypothetical peptide fragments obtained by cleaving the hypothetical peptide predicted from the gene at the predetermined site above:

(i) modification of amino acid residue,
(ii) amino acid substitution,
(iii) change in gene expression pattern, and
(iv) cleavage of N-terminal-sided or C-terminal-sided amino acid residue.

In the analytical method, analyses if at least one of the above (i) to (iv) is preformed by using unidentified peaks analyte protein conventionally unused. Thus, it is possible to obtain information inherent to the proteins actually expressed in the body. Such information can not be obtained from the information on gene identified, for example, by existing databases, and thus, it is possible to analyze the primary structure or the modification state of proteins in more detail by us the analytical method according to the present invention.

In the present invention, it is also possible to obtain finding, for example, about whether the change (i) to (iv) is occurring in the analyte protein, by the analyses of (i) to (iv). If the change does exist, it is also possible to obtain finding on the pattern of the change.

In the present invention, the processing in the identifying the gene may be performed by the PMF method by using existing databases. In this way, it is possible to identify genes reliably.

In the method of analyzing a protein according to the present invention, the unidentified peaks among the peaks and the undetected peptides not corresponding to the peaks present in the mass spectrum among the hypothetical peptide fragments may be used in the processing in the analyzing at least one of the above (i) to (iv). In this way, it is possible to analyze the analyte protein more in detail.

According to the present invention, there is provided a method of analyzing a protein, including cleaving an analyte protein at a predetermined site selectively and obtaining the mass spectrum of the peptide fragments generated, identifying the gene corresponding to the protein by using the peaks contained in the mass spectrum, and analyzing the following (i), (ii), (iii), and (iv) by using unidentified peaks not corresponding to the hypothetical peaks present in the hypothetical mass spectra of the hypothetical peptide fragments obtained by cleaving the hypothetical peptide predicted from the gene at the predetermined site above and the undetected peptides not corresponding to the peaks present in the mass spectrum among the hypothetical peptide fragments among the peaks:

(i) modification of amino acid residue,
(ii) amino acid substitution,
(iii) change in gene expression pattern, and
(iv) cleavage of N-terminal-sided or C-terminal-sided amino acid residue.

In the analytical method, all of the analyses of (i) to (iv) are preformed. Thus, it is possible to obtain information inherent to the protein actually expressed in the body more in detail. It is thus possible to analyze the primary structure and the modification state of the protein more in detail.

In the method of analyzing a protein according to the present invention, the identifying the gene may contain extracting fragments containing a serine or threonine residue in their amino acid sequences from the undetected peptides not corresponding to the peaks present in the mass spectrum among the hypothetical peptide fragments, and determining whether there are the unidentified peaks of proteins having a mass corresponding to the mass of the extracted fragments when dehydrated, regarding the unidentified peaks, if present, as identified, and regarding the corresponding undetected peptides as detected fragments. In this way, it is possible to analyze any one of the above (i) to (iv), considering the dehydration reaction occurring on the analyte protein. It is thus possible to analyze the primary structure or the modification state of the protein more reliably.

In the method of analyzing a protein according to the present invention, the analyzing modification of amino acid residue (i) may include determining the difference in mass between the undetected peptides not corresponding to the peaks present in the mass spectrum among the hypothetical peptide fragments and the unidentified peaks, and comparing the difference with the increase in mass by modification of the amino acid residue in the proteins and judging that there is the modification if the difference is identical with the increase. In this way, it is possible to analyze the modification state of the amino acid residue of the protein more reliably.

In the present specification, the term “modification” means natural modification of protein. The modification may be modification on the side chain of an amino acid residue or at the N terminal or C terminal thereof.

In the method of analyzing a protein according to the present invention, the analyzing amino acid substitution (ii) may include extracting the unidentified peak having a mass mₑₓ satisfying the Formula: mₜₕ−151≦mₑₓ≦mₜₕ+151, with respect to the mass mₜₕ of the undetected peptide not corresponding to the peaks present in the mass spectrum among the hypothetical peptide fragments; comparing the value mₑₓ−mₜₕ with the value of mass change that may occur by amino acid substitution and determining whether the value mₑₓ−mₜₕ is a value specific to the amino acid substitution, and determining whether the amino acid residue corresponding to the amino acid substitution is included in the undetected peptide when the value mₑₓ−mₜₕ is a value specific to the amino acid substitution, and, if it is included, regarding that there is amino acid substitution. In this way, it is possible to detect reliably amino acid substitutions not involving arginine and lysine residues and amino acid substitutions from lysine to arginine residue and from arginine to lysine residue.

In the method of analyzing a protein according to the present invention, the analyzing amino acid substitution (ii) may include extracting the unidentified peaks having a mass mₑₓ or a mass mₑₓ′ satisfying the following Formula (1), with respect to the mass mₜₕ of the undetected peptide not corresponding to the peaks present in the mass spectrum among the hypothetical peptide fragments, determining whether there is the amino acid residue Y corresponding to Δm_{YX} in the following Formula (1) in the undetected peptides, and determining whether there are the unidentified peaks corresponding to the mass of the hypothetical peptide fragments predicted to be generated by amino acid substitution in the mass spectrum of the protein and regarding, if present, that there is amino acid substitution:

mₑₓ+mₑₓ′−18=mₜₕ+Δm_{YX} (1)

(in Formula (1), Δm_{YX} represents the mass change when an amino acid residue Y not at the cleavage site is substituted with the amino acid residue X at the cleavage site; and plurality of the amino acid residues X different in kind may be present).

In this way, it is possible to analyze reliably whether an amino acid residue not at the cleavage site is substituted with another amino acid residue which forms another cleavage site.

In the method of analyzing a protein according to the present invention, the analyzing amino acid substitution (ii) may include extracting the unidentified peaks having a mass mₑₓ satisfying the following Formula (2) with respect the neighboring undetected peptides having a mass mₜₕ and a mass mₜₕ′ in the sequence of the hypothetical peptide, from the undetected peptides not corresponding to the peaks present in the mass spectrum among the hypothetical peptide fragments, and determining whether the peaks corresponding to the undetected peptides having a mass mₜₕ and a mass mₜₕ′ are absent in the mass spectrum of the protein and regarding, if absent, that there is amino acid substitution:

mₜₕ+mₜₕ′−18=mₑₓ+Δm_{YX} (2)

(in Formula (2), Δm_{YX} represents the mass change when an amino acid residue Y not at the cleavage site is substituted with the amino acid residue X at the cleavage site; and the amino acid residue X at the cleavage site is restricted to be an amino acid residue at the boundary of two of the undetected peptides).

In this way, it is possible to analyze reliably whether an amino acid residue at the cleavage site is substituted with another amino acid residue which annihilates the cleavage site.

In the method of analyzing a protein according to the present invention, the analyzing amino acid substitution (ii) may include extracting the unidentified peaks having a mass mₑₓ and a mass mₑₓ′ satisfying the following Formula (3) or (4) with respect to the mass mₜₕ of the undetected peptide not corresponding to the peaks present in the mass spectrum among the hypothetical peptide fragments, determining whether there is an amino acid residue X corresponding to Δm_{XR} or Δm_{XK} in the following Formula (3) or (4) in the undetected peptides, and determining whether there are the unidentified peaks corresponding to the mass of the hypothetical peptide fragments predicted to be generated by the amino acid substitution in the mass spectrum of the protein and regarding, if present, that there is amino acid substitution:

mₑₓ+mₑₓ′−18=mₜₕ+Δm_{XR} (3)

mₑₓ+mₑₓ′−18=mₜₕ+Δm_{XK} (4)

(in Formula (3), Δm_{XR} represents the mass change when the amino acid residue X is substituted with an arginine residue R; and in Formula (4), Δm_{XK} represents the mass change when the amino acid residue X is substituted with a lysine residue K).

In this way, it is possible to analyze reliably whether an amino acid residue other than arginine and lysine residues is substituted with an arginine or lysine residue.

In the method of analyzing a protein according to the present invention, the analyzing amino acid substitution (ii) may include extracting the unidentified peak having a mass mₑₓ satisfying the following Formula (5) or (6) from the undetected peptides not corresponding to the peaks present in the mass spectrum among the hypothetical peptide fragments, with respect the neighboring undetected peptides having a mass mₜₕ and a mass mₜₕ′ in the sequence of the hypothetical peptide, and determining whether the peaks corresponding to the undetected peptides having a mass mₜₕ and a mass mₜₕ′ are absent in the mass spectrum of the protein and regarding, if absent, that there is amino acid substitution:

mₜₕ+mₜₕ′−18=mₑₓ+Δm_{XR} (5)

mₜₕ+mₜₕ′−18=mₑₓ+Δm_{XK} (6)

(in Formula (5), Δm_{XR} represents the mass change when the amino acid residue X is substituted with an arginine residue R; and in Formula (6), Δm_{XK} represents the mass change when the amino acid residue X is substituted with a lysine residue K).

In this way, it is possible to analyze reliably whether there is substitution from an arginine or lysine residue to an amino acid residue other than arginine and lysine residues residue.

In the method of analyzing a protein according to the present invention, the analyzing the change in gene expression pattern (iii) may include analyzing the frameshift mutation or splicing mutant of the protein.

In the method of analyzing a protein according to the present invention, the analyzing the change in gene expression pattern (iii) may include determining the hypothetical amino acid sequence of the hypothetical peptide hypothetically translated from the region between A(adenine)G(guanine) and GT(thymine), the region between AG and the terminal of the closest exon, the region between the terminal of the closest exon and GT among all regions in the gene predicted as introns, and comparing the mass of the fragments of the hypothetical amino acid sequence when it is hypothetically trypsin-digested with the mass of the unidentified peak and regarding, if they are identical with each other, that there is splicing mutation. In this way, it is possible to analyze reliably whether there is splicing mutation in the analyte protein.

In the method of analyzing a protein according to the present invention, the analyzing the change in gene expression pattern (iii) may include determining the amino acid sequence of the polypeptides hypothetically translated in three reading frames from all undetected exons and introns, determining whether the mass of the hypothetical peptide fragments obtained by trypsin digestion of the polypeptides are identical with the mass of the unidentified peaks and regarding, if they are identical with each other, that there is splicing mutation. In this way, it is possible to analyze reliably whether there is splicing mutation in the analyte protein.

In the method of analyzing a protein according to the present invention, the analyzing the change in gene expression pattern (iii) may include examining whether the mass of the hypothetical peptide fragments obtained by hypothetical trypsin digestion of the peptides having an amino acid sequence predicted to be generated when the base sequence of the undetected regions in the exons containing the region coding the amino acid sequence of the detected peptide is translated while the reading frame is shifted by one or two bases with the mass of unidentified peaks and regarding, if there are some identical with each other, that there is frameshift mutation. In this way, it is possible to analyze reliably whether there is frameshift mutation in the analyte protein.

In the method of analyzing a protein according to the present invention, the analyzing the cleavage of N-terminal-sided or C-terminal-sided amino acid residue (iv) may include calculating the mass of the undetected peptide locating closer to the C terminal than the detected peptide closest to the C terminal among the undetected peptides not corresponding to the peaks present in the mass spectrum, when an amino acid residue is cleaved stepwise from the C-terminal side, and determining whether an unidentified peak having a mass identical with the mass of the peptide is present in the mass spectrum and regarding, if present, that there is cleavage of the C-terminal-sided amino acid residue. In this way, it is possible to analyze reliably whether there is cleavage of C-terminal amino acid residues from the hypothetical peptide in the analyte protein.

In the method of analyzing a protein according to the present invention, the analyzing the cleavage of N-terminal-sided or C-terminal-sided amino acid residue (iv) may include calculating the mass of the peptides obtained from the undetected peptide locating closer to the N terminal side than the detected peptide closest to the N terminal among the undetected peptides not corresponding to the peaks present in the mass spectrum when an amino acid residue thereof is cleaved stepwise from the N terminal side, and determining whether there are unidentified peaks having a mass identical with the mass of the peptide in the mass spectrum and regarding, if present, that there is cleavage of N-terminal-sided amino acid residue. In this way, it is possible to analyze reliably whether there is cleavage of N-terminal side amino acid residues from the hypothetical peptide in the analyte protein.

In the method of analyzing a protein according to the present invention, the analyzing the cleavage of N-terminal-sided or C-terminal-sided amino acid residue (iv) may be analyzing single amino acid residue cleavage or analyzing cleavage of an N-terminal-sided or C-terminal-sided peptide. It is possible to analyze the primary structure of the expressed sample protein more reliably, by analysis of the cleavage of a N-terminal-sided or C-terminal-sided peptide.

In the method of analyzing a protein according to the present invention, the analyzing may include performing MS/MS measurement of the peptide fragments. It is possible in this way to perform analysis more accurately.

As described above, the present invention provides a technique of analyzing the primary structure or the modification state of proteins more in detail, by using unidentified peaks not corresponding to the hypothetical peaks present in the hypothetical mass spectra of the hypothetical peptide fragments obtained by cleaving a hypothetical peptide predicted from identified genes at a predetermined site.

### BRIEF DESCRIPTION OF THE DRAWINGS

The objects described above, other objects, the characteristics and advantages of the invention will be more apparent with reference to the preferred embodiments described below and the following drawings associated therewith.

FIG. 1 is a flow chart showing the procedure of analyzing a protein according to the present embodiment.

FIG. 2 is a flow chart showing the procedure of analyzing a protein according to the present embodiment.

FIG. 3 is a flow chart showing the procedure of analyzing a protein according to the present embodiment.

FIG. 4 is a flow chart showing the procedure of analyzing a protein according to the present embodiment.

FIG. 5 is a flow chart showing the procedure of analyzing a protein according to the present embodiment.

FIG. 6 is a flow chart showing the procedure of analyzing a protein according to the present embodiment.

FIG. 7 is a chart explaining an analytical method by using the procedure shown in FIG. 6.

FIG. 8 is a flow chart showing the procedure of analyzing a protein according to the present embodiment.

FIG. 9 is a chart explaining an analytical method by using the procedure shown in FIG. 8.

FIG. 10 is a chart explaining an analytical method by using the procedure shown in FIG. 8.

FIG. 11 is a flowchart showing the procedure of analyzing a protein according to the present embodiment.

FIG. 12 is a chart explaining an analytical method by using the procedure shown in FIG. 11.

FIG. 13 is a chart explaining an analytical method by using the procedure shown in FIG. 11.

FIG. 14 is a flowchart showing the procedure of analyzing a protein according to the present embodiment.

FIG. 15 is a flow chart showing the procedure of analyzing a protein according to the present embodiment.

FIG. 16 is a flowchart showing the procedure of analyzing a protein according to the present embodiment.

FIG. 17 is chart showing the method of analyzing a protein according to the present embodiment.

FIG. 18 is a chart showing the method of analyzing a protein according to the present embodiment.

FIG. 19 is a table showing the amino acid sequence and the trypsin digestion site of human hemoglobin β-chain.

FIG. 20 is a table showing the amino acid sequence and the trypsin digestion site of human hemoglobin S β-chain.

FIG. 21 is a graph showing a mass spectrum of human hemoglobin β-chain according to an Example.

FIG. 22 is a graph showing a mass spectrum of human hemoglobin S β-chain according to an Example.

FIG. 23 is a graph showing a mass spectrum of human hemoglobin β-chain according to Example.

FIG. 24 is a graph showing a mass spectrum of human hemoglobin S β-chain according to Example.

### BEST MODE FOR CARRYING OUT THE INVENTION

Hereinafter, preferred embodiments of the present invention will be described with reference to drawings.

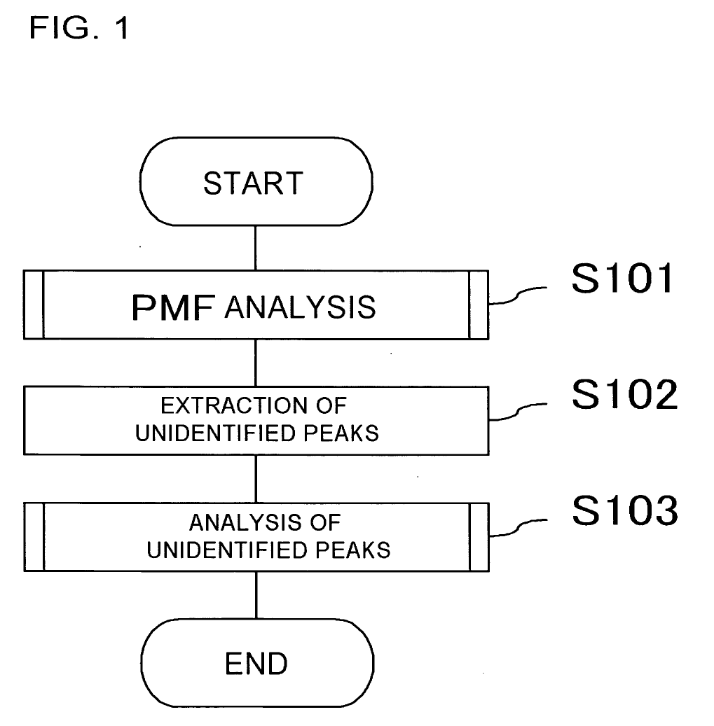

FIG. 1 is a flow chart showing an example of the procedure of analyzing a protein according to the present invention. In the analytical method shown in FIG. 1, an analyte protein is subjected to PMF analysis (S101), for identification of the gene of the protein.

In the following embodiments, the gene identified by PMF analysis will be called a “hypothetical gene”. The amino acid sequence of the protein predicted from the hypothetical gene will be called a “hypothetical amino acid sequence”. The peptide fragment predicted to be generated by site-selective fragmentation of protein from the hypothetical amino acid sequence will be called a “hypothetical peptide fragment”. In addition, the mass spectrum predicted to be obtained from the hypothetical peptide fragment will be called a “hypothetical mass spectrum”.

In the following embodiments, the term “identification” means to make the identity of a peak clear scientifically in mass spectrometric analysis. Alternatively, the term “detection” means that a peak corresponding to the hypothetical peptide fragment predicted from the gene identified in PMF analysis is observed in mass spectrum.

Also in the following embodiments, the term “unidentified peak” means a peak non-corresponding to the peaks in hypothetical mass spectrum among the peaks in the mass spectrum observed in PMF analysis of an analyte protein. The term “undetected peptide” means a hypothetical peptide fragment corresponding to the peak unobserved in PMF analysis, among the peaks in hypothetical mass spectrum.

After Step 101, unidentified peaks non-corresponding to the peaks of hypothetical peptide fragments are extracted, by comparing the hypothetical mass spectrum with the mass spectrum obtained by mass spectrometry of a sample protein (S102). The procedure of extracting the unidentified peaks will be described in detail in the first embodiment.

The unidentified peaks obtained are then analyzed, and the primary structure and the modification state of the protein are analyzed in detail (S103).

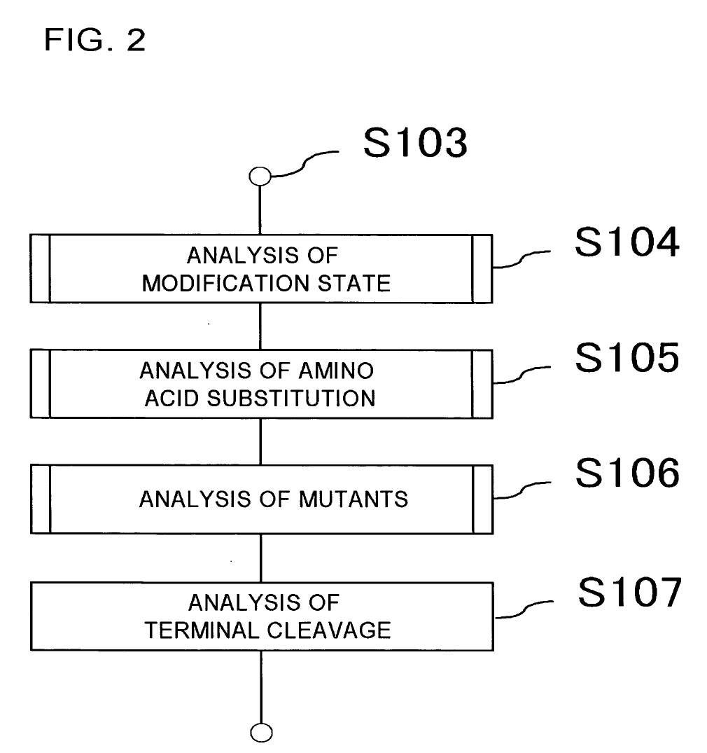

FIG. 2 is a flow chart showing the procedure of analyzing unidentified peaks in Step 103. In Step 103, the modification state of side chains or the terminal of the amino acid residue of the protein is analyzed (S104). In addition, substitution from the amino acid residues in the hypothetical amino acid sequence is analyzed (S105). Change in the expression pattern from the hypothetical gene is also analyzed (S106). Cleavage of peptides from the N terminal or C terminal of the hypothetical amino acid sequence is also analyzed (S107).

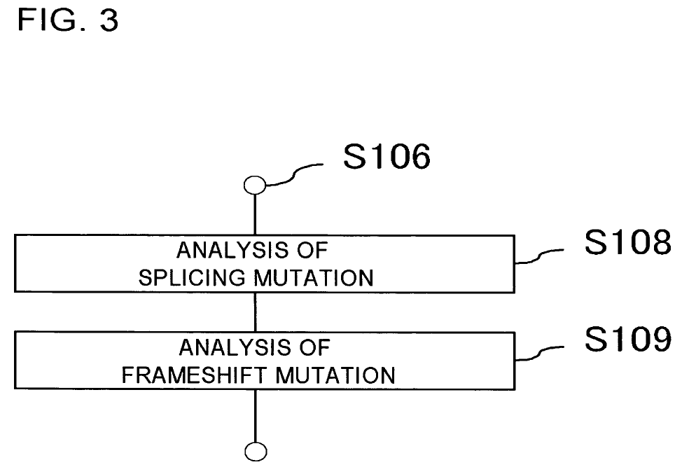

FIG. 3 is a flow chart showing the mutational analysis performed in Step 106 of FIG. 2. In Step 106, splicing mutation of the analyte protein is analyzed (S108). In addition, frameshift mutation of the analyte protein is analyzed (S109).

In FIG. 2, all analyses in Steps 104 to 107 are performed in that order, but one or more of Steps 104 to 107 may be performed as selected; and only one or two of the steps may be performed as needed.

Analyses in Steps 108 and 109 are performed similarly in series in FIG. 3, but at least one of these steps may be performed during the analysis in Step 106, and only one of them may be selected as needed.

Typical analytical methods in each Step 104 to 107 will be described in detail in each of the second to fifth embodiments sequentially.

It is possible to analyze a protein in detail in these analyses, specifically, to perform analysis of the modification state of protein and to obtain information on the presence and the kind of amino acid substitution from the hypothetical amino acid sequence, the presence and the pattern of mutation from an identified gene, and the presence of N-terminal or C-terminal cleavage from the hypothetical amino acid sequence and the number of amino acids contained in a cleaved peptide, by using unidentified peaks that are unused in conventional PMF analysis (Step 101). Thus, it is possible to obtain information on the primary structure and the modification state of a protein, which could not be obtained from gene information, by making the most use of the mass spectrum of the protein.

Hereinafter, each of the steps will be described specifically.

### FIRST EMBODIMENT

The present embodiment relates to the specific procedure in each of the Steps 101 to 102 in FIG. 1.

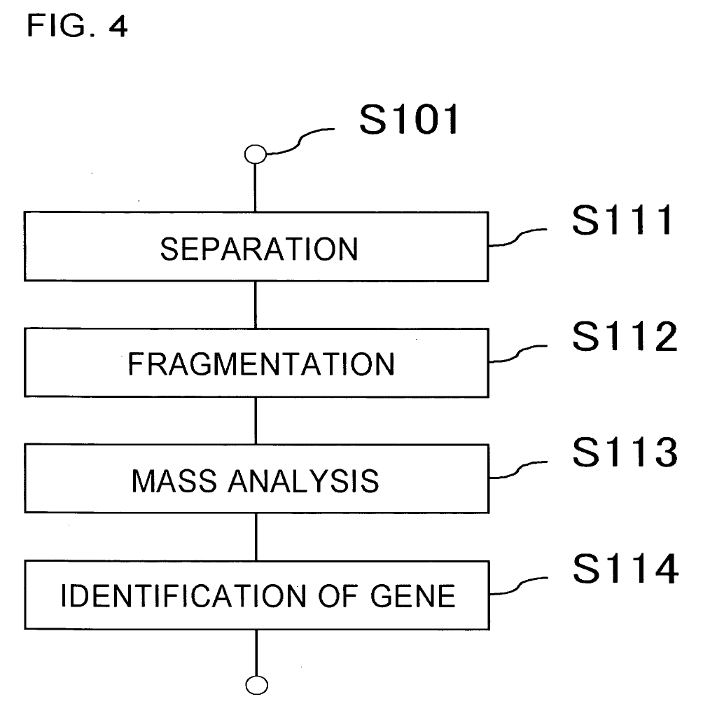

In Step 101, the gene associated with a sample protein is identified by common PMF analysis. FIG. 4 is a flow chart showing the procedure of the PMF analysis in Step 101.

In FIG. 4, a desirable protein is first separated from an analyte protein-containing sample, for example, by two-dimensional electrophoresis (S111). The protein is fragmented chemically or enzymatically (S112). For example, trypsin digestion may be used in enzymatic fragmentation. It is possible in this way to fragment the protein selectively at the C-terminal side of a basic amino acid residue. The following embodiments will be described, taking fragmentation of an analyte peptide with trypsin as an example.

Then, the peptide fragments generated are subjected to mass spectrometry, giving a mass spectrum (S113). Examples of the mass spectrometers for use in mass spectrometry include ion trap mass spectrometer, quadruple mass spectrometer, magnetic-field mass spectrometer, time-of-flight (TOF) mass spectrometer, Fourier-transform mass spectrometer, and the like. Examples of the ionization methods include electrospray ionization (ESI), matrix-assisted laser desorption/ionization (MALDI), fast atom bombardment (FAB), and the like.

Among them, for example, MALDI-TOF-MS is preferably used. It is possible to suppress the deletion of part of atom groups from the amino acid residues constituting the protein in the ionization process by using the MALDI-TOF-MS. It is also possible to analyze peptide fragments having a relatively higher molecular weight preferably. In addition, even when the analyte protein is isolated from the sample by gel electrophoresis, treated in the gel as described above, and recovered before analysis, it is possible to analyze both of the corresponding anions and cations. For that reason, use of the MALDI-TOF-MS allows analysis higher in reproducibility.

The length of the peptide fragment to be subject to the mass spectrometric analysis in step 113 is, for example, less than 20 to 30 amino acid residues. In this way, it is possible to ionize the peptide fragments reliably during mass spectrometric analysis.

Then, genes corresponding to the sample protein are identified significantly by retrieval of the existing databases (S114). At the time, known noise peaks such as autolytic fragment derived from the digestive enzyme and fragments derived from keratin may be removed from the mass spectrum of sample protein, and then only typical peaks are selected and retrieved from the databases.

If parts of the peaks present in the mass spectrum of sample protein are identical in mass with the hypothetical peptide fragments predicted from database and the corresponding genes are identified by database retrieval, the identical peaks are identified.

Back in Step 102 of FIG. 1, unidentified peaks, which are not identified in Step 114 (FIG. 4), are extracted. Even sample protein-derived peaks are removed if the intensity thereof is insufficient by selection before database retrieval. Thus, the sample protein-derived peaks may be present in the unidentified peaks in this stage.

It is first judged whether the peaks of the fragments remaining undetected are present in the measured spectrum with reference to the masses of the hypothetical peptide fragment predicted from identified genes. At the time, peaks lower in intensity should also be examined carefully. Among the peaks in measured spectrum only peaks identical with the information in the database are identified in the operation.

The peaks identified in the operation above will be called identified peaks. The peaks unidentified are unidentified peaks, and undetected presumptive fragments derived from identified gene are undetected peptides.

Considering the chemical change that may occur in the experimental process, unidentified peaks may be extracted in Step 102.

There are chemical changes inevitably occurring in the experimental process in Step 101. Such a chemical change may lead to generation of unidentified peaks in PMF analysis and also to generation of noise in later analysis, and thus, a measure should be taken individually according to the chemical change. Measures to the following chemical changes (a) to (d) will be considered.

### (a) D-P Cleavage

When there is a D (aspartic acid)-P (proline) bond in the amino acid sequence of sample protein, cleavage reaction often occurs at the position. The cleavage reaction gives two unidentified peaks in mass spectrum.

The following measure is taken for prevention. Among the hypothetical peptide fragments predicted from genes identified in Step 114 (FIG. 4), attention is given to undetected peptides. Peptide fragments containing the D-P sequence in their amino acid sequences are selected. The mass of the sub-fragments generated if the selected fragments are cleaved at the D-P bond is calculated. It is judged whether there are unidentified peaks at the positions of the calculated values in the mass spectrum of sample protein. If there are unidentified peaks, the unidentified peaks are regarded as identified. And, corresponding undetected peptides are also regarded as detected.

### (b) Non-Cleavage of K-P and R-P

The cleavage sites of protein when fragmented by trypsin digestion are the peptide bonds immediately after K (lysine) and R (arginine) residues. However, when the C-terminal-sided amino acid of K or R is P, the peptide is not cleaved. Thus, the K-P or R-P sequence is a noncleavage site, and a noncleavage site gives an unidentified peak and two undetected peptides.

In regard to the phenomenon, it is assumed that there is no cleavage of the K-P and R-P peptide bonds during prediction of the mass pattern of trypsin-digested fragments by using database in Step 114 (FIG. 4) in the database retrieval stage of PMF analysis.

### (c) Oxidation of M

M (methionine) is oxidized in two ways, monovalently and bivalently. The monovalent oxidation results in a mass shift of 16, while the bivalent oxidation results in a mass shift of 32. The monovalent oxidation is a reversible reaction, while the bivalent oxidation an irreversible reaction. When a peptide fragment contains an oxidized M, the peak of the peptide fragment is an unidentified peak, and an undetected peptide is generated to each corresponding hypothetical fragment peptide.

Thus, the following measure is taken to the reaction. First, attention is given to undetected peptides in the hypothetical peptide fragments predicted from the identified hypothetical gene, and peptides having M in their amino acid sequence are selected from them. The mass of the selected fragments is calculated under the assumption that oxidation of M occurs in the selected fragments. Specifically, monovalent oxidation reaction leads to increase in mass of 16, while bivalent oxidation reaction, increase in mass of 32. It is judged whether there are unidentified peaks at the positions of calculated values, and, if present, the unidentified peaks are regarded as identified. Corresponding hypothetical peptide fragments are also regarded as detected.

### (d) Dehydration Reaction

S (serine) and T (threonine) residues may be dehydrated respectively into dehydroalanine and dehydrobutyrine. The reaction accompanies a mass shift of −18 in both cases.

Among the hypothetical peptide fragments predicted from the identified hypothetical gene, undetected peptides containing S or T in their amino acid sequences are selected. The mass of the selected fragments is calculated under the assumption that dehydration reaction occurs in the selected fragments. With reference to the mass spectrum of the analyte protein, it is judged whether there are unidentified peaks at the positions of calculated values. If present, the unidentified peaks are regarded as identified, and corresponding hypothetical peptide fragments are also regarded as detected.

By taking the measures (a) to (d), it is possible to extract unidentified peaks, considering the chemical change that may occur in the experimental process. It is thus possible to perform protein analysis at higher accuracy by using unidentified peaks.

The measures (a) to (d) may be taken in the stage of PMF analysis in Step 101. The peaks identified from the results when the operations above are performed, are called identified peaks, those unidentified are called unidentified peaks, and the undetected presumptive fragments derived from identified gene are called undetected peptides, and the procedure advances to the analysis in Step 103.

### SECOND EMBODIMENT

The present embodiment relates to the procedure of the analysis of modification state (S104) in FIG. 2 in the analysis of unidentified peaks (S103) in FIG. 1.

If generation of the unidentified peaks extracted in the first embodiment is caused by the modification of side chain in Step 104, the unidentified peaks should be present at positions shifted by a predetermined mass difference from the mass of undetected peptides in the mass spectrum of the analyte protein. For analysis of the possibility of protein modification, the possibility of the modification of the amino acid residues in the sample is analyzed by determining whether there are unidentified peaks at positions shifted by a particular mass from the mass of each of the undetected peptides in the present embodiment.

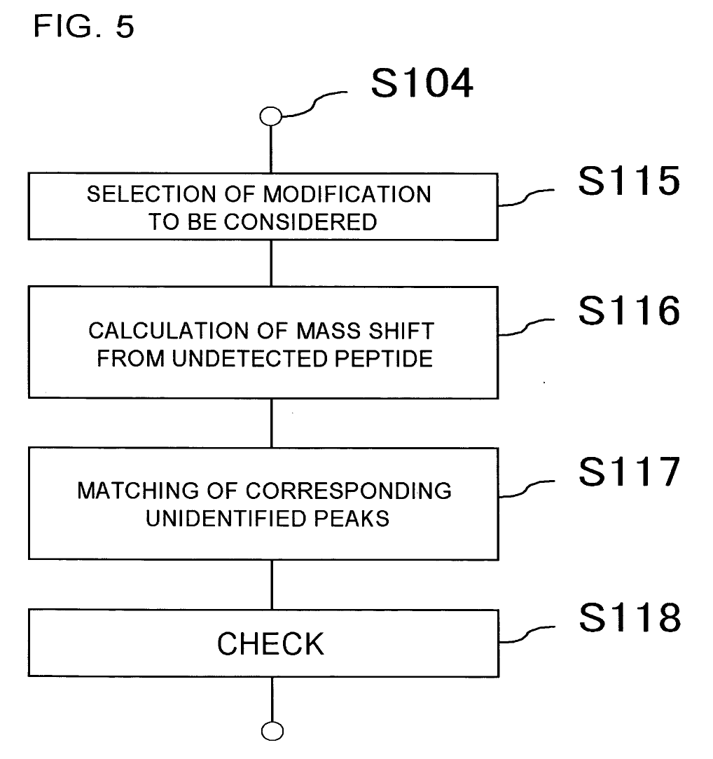

FIG. 5 is a flow chart showing the procedure of analyzing modification state. As shown in FIG. 5, a modification to be considered is first selected (S115). The mass of the fragment of each undetected peptide in the hypothetical peptide fragments after mass shift by the modification selected in Step 115 is calculated (S116). It is judged then whether there is an unidentified peak corresponding to the obtained mass, in the mass spectrum of sample protein (S117). If a corresponding unidentified peak is observed, it is judged whether there is post-translational modification, for example, by MS/MS measurement (S118). Hereinafter, each of the steps will be described.

In Step 115, a typical modification that occurs on the side chain of amino acid residue is selected. However, a mass difference of 16 may not be considered, if it is already analyzed in the first embodiment. A modification frequently occurring on natural proteins or a modification deeply involved in the phenomenon under study may be selected as the “typical modification”. Modifications not selected as the “typical modification” will be called “rare modification”.

Tables 1 to 7 are lists showing examples of the modification that may occur on the side chain of amino acid residues and the corresponding mass differences. Table 8 is a table showing modifications frequently occurring on natural proteins, among the modifications shown in Tables 1 to 7. More specifically, in Step 115, at least part of the modifications shown in Table 8 may be regarded as typical modifications, and modifications not shown in Table 8 among the modifications shown in Tables 1 to 7 as rare modifications.

TABLE 1

| MASS | |
|---|---|
| DIFFERENCE | |
| | KIND OF MODIFICATION |
| −79 | 5′dephospho |
| −58 | Desmosine (from Lysine) |
| −48 | decomposed carboxymethylated Methionine^{†} |
| −44 | decarboxylation of gamma carboxy Glutamate^{†} |
| −43 | gamma-glutamyl semialdehyde (from arginine) |
| −42 | Ornithine (from Arginine)* |
| −34 | Lysinoalanine (from Cysteine) |
| −34 | Lanthionine (from Cysteine) |
| −34 | Dehydroalanine (from Cysteine) |
| −30 | Homoserine formed from Met by CNBr treatment |
| −18 | Formylglycine (from cysteine) |
| −18 | Pyroglutamic Acid formed from Glutamic Acid |
| −18 | Dehydration (—H₂O) |
| −18 | S-gamma-Glutamyl (crosslinked to Cysteine) |
| −18 | O-gamma-Glutamyl-(Crosslink to Serine) |
| −18 | Serine to Dehydroalanine |
| −18 | Alaninohistidine (Serine crosslinked to theta or |
| | pi carbon of Histidine) |
| −18 | Misincorporation of Norleucine for Methionine |
| −18 | Succinimide formation from aspartic acid |
| −17 | Pyroglutamic Acid formed from Gln |
| −17 | N-pyrrolidone carboxyl (N terminus) |
| −17 | N alpha-(gamma-Glutamyl)-lysine |
| −17 | N-(beta-Aspartyl)-Lysine (Crosslink) |
| −17 | Succinimide formation from asparagine |
| | MODIFICATION |
| −17 | S-carbamoylmethylcysteine cyclization (N-terminus) |
| −16 | Pyruvoyl-(Serine) |
| −5 | Crosslink between Arg and His sidechains |
| −4 | 3,3′,5,5′-TerTyr (Crosslink) |
| −2 | Formylglycine (from serine) |
| −2 | Disulphide bond formation (Cystine) |
| −2 | S-(2-Histidyl)-(Crosslinked to Cysteine) |
| −2 | S-(3-Tyr) (Crosslinked to Cysteine) |
| −2 | 3,3′-BiTyr (Crosslink) |
| −2 | IsodiTyr (Crosslink) |
| −1 | Allysine(from Lysine) |
| −1 | Amide formation (C terminus) |
| 1 | Deamidation of Asparagine and Glutamine to |
| | Aspertate and Glutamate |
| 1 | Citruline (from Arginine) |
| 2 | Cysteine ×2, reduction of Cystine (Cys-Cys) |
| 2 | Reduction of indole double bond of Trp |
| 12 | Lysine epsilon amino to imine |
| 12 | Cysteine (N-term) formaldehyde adduct |
| | (Cys to Thioproline conversion) |
| 12 | Formaldehyde adduct of Trp |
| 13 | Syndesine (from Lysine) |
| 13 | CM-Cys vs PAM-Cys |
| 14 | Methylation (N terminus, N epsilon of Lysine, O of |
| | Serine, Threonine or C terminus, N of Asparagine) |
| 14 | CAM-Cys vs PAM-Cys |
| 15 | delta-Hydroxy-allysine (from Lysine) |

THE UNIT OF MASS DIFFERENCE IS Da.

TABLE 2

| MASS | |
|---|---|
| DIFFERENCE | KIND OF MODIFICATION |
| 16 | Hydroxylation (of delta C of Lysine, beta C of |
| | Tryptophan, C3 or C4 of Proline, beta C of Aspertate) |
| 16 | Oxidation of Methionine (to Sulphoxide) |
| 16 | 3,4-Dihydroxy-Phenylalanine (from Tyrosine) (DOPA) |
| 16 | Oxohistidine (from histidine) |
| 16 | Sulfenic Acid (from Cysteine) |
| 22 | Sodium |
| 28 | Ethyl |
| 28 | N,N dimethylation (of Arginine or Lysine) |
| 28 | 2,4-BisTrp-6,7-dione (from Tryptophan) |
| 28 | Formylation (CHO) |
| 30 | 6,7 Dione (from Tryptophan) |
| 32 | 3,4,6-Trihydroxy-Phenylalanine (from Tyrosine) (TOPA) |
| 32 | 3,4-Dihydroxylation (of Proline) |
| 32 | Oxidation of Methionine (to Sulphone) |
| 34 | 3-Chlorination (of Tyrosine with ³⁵Cl) |
| 36 | 3-Chlorination (of Tyrosine with ³⁷Cl) |
| 38 | Potassium |
| 42 | Acetylation (N terminus, N epsilon of Lysine, |
| | O of Serine) (Ac) |
| 42 | N-Trimethylation (of Lysine) |
| 43 | Carbamylation |
| 44 | disodium |
| 45 | Nitro (NO₂) |
| 46 | beta-Methylthio-aspertic acid |
| 48 | Cysteic acid, oxidation of cysteine |
| 51 | Piperidine adduct to C-terminal Cys |
| 56 | t-butyl ester(OtBu) and t-butyl (tBu) |
| 57 | Glycyl (-G-, -Gly-) |
| 57 | Carboxamidomethyl (on Cysteine) |
| 58 | Carboxymethyl (on Cysteine) 60 sodium + potassium |
| 64 | Selenocysteine (from Serine) |
| 67 | Asp transamidation with piperidine |
| 68 | 3,5-Dichlorination (of Tyrosine with ³⁵Cl) |
| 69 | Dehydroalanine (Dha) |
| 70 | 3,5-Dichlorination (of Tyrosine with mixture |
| | of ³⁵Cl and ³⁷Cl)) |
| 70 | Pyruvate |
| 71 | Sarcosyl |
| 71 | Alanyl (-A-, -Ala-) |
| 71 | Acetamidomethyl (Acm) |
| 71 | Propionamide or Acrylamide adduct |
| 72 | 3,5-Dichlorination (of Tyrosine with ³⁷Cl) |
| 74 | S-(sn-1-Glyceryl) (on Cysteine) |
| 74 | Glycerol Ester (on Glutamic acid side chain) |
| 75 | Glycine (G, Gly) |
| 76 | Phenyl ester (OPh) (on acidic) |
| 76 | Beta mercaptoethanol adduct |
| 78 | 3-Bromination (of Tyrosine with ⁷⁹Br) |
| 78 | L-o-bromination of Phe with ⁷⁹Br |
| 80 | L-o-bromination of Phe with ⁸¹Br |

THE UNIT OF MASS DIFFERENCE IS Da.

TABLE 3

| MASS | |
|---|---|
| DIFFERENCE | KIND OF MODIFICATION |
| 80 | Sulphonation (SO₃H) (of PMC group) |
| 80 | Sulphation (of O of Tyrosine) |
| 80 | Phosphorylation (O of Serine, Threonine, Tyrosine and |
| | Aspertate, N epsilon of Lysine) |
| 80 | 3-Bromination (of Tyrosine with ⁸¹Br) |
| 82 | Cyclohexyl ester (OcHex) |
| 83 | Dehydroamino butyric acid (Dhb) |
| 83 | Homoseryl lactone |
| 85 | 2-Aminobutyric acid (Abu) |
| 85 | 2-Aminoisobutyric acid (Aib) |
| 85 | Gamma Aminobutyryl |
| 86 | t-butyloxymethyl (Bum) |
| 86 | Diaminopropionyl |
| 87 | N-(4-NH2-2-OH-butyl)-(of Lysine) (Hypusine) |
| 87 | Seryl (-S-, -Ser-) |
| 88 | t-butylsulfenyl (StBu) |
| 89 | Alanine (A, Ala) |
| 89 | Sarcosine (Sar) |
| 90 | Anisyl |
| 90 | Benzyl (Bzl) and benzly ester (OBzl) |
| 93 | 1,2-ethanedithiol (EDT) |
| 95 | Dehydroprolyl |
| 96 | Trifluoroacetyl (TFA) |
| 97 | N-hydroxysuccinimide (ONSu, OSu) |
| 97 | Prolyl (-P-, -Pro-) |
| 97 | Prolyl (-P-, -Pro-) |
| 98 | Cysteic acid ×2, oxidation of cystine |
| 98 | Tetramethylguanidinium termination by-product on |
| | amine |
| 99 | Valyl (-V-, -Val-) |
| 99 | Isovalyl (-I-, -Iva-) |
| 100 | t-Butyloxycarbonyl (tBoc) |
| 101 | Threoyl (-T-, -Thr-) |
| 101 | Homoseryl (-Hse-) |
| 103 | Cystyl (-C-, -Cys-) |
| 104 | 4-Methylbenzyl (Meb) |
| 104 | Benzoyl (Bz) |
| 105 | Serine (S, Ser) |
| 105 | Pyridylethylation of cysteine |
| 106 | HMP (hydroxymethylphenyl) linker |
| 106 | Thioanisyl |
| 106 | Thiocresyl |
| 107 | Diphthamide (from Histidine) |
| 111 | 2-Piperidinecarboxylic acid (Pip) |
| 111 | Pyroglutamyl |
| 113 | Hydroxyprolyl (-Hyp-) |
| 113 | Isoleucyl (-I-, -Ile-) |
| 113 | Leucyl (-L-, -Leu-) |
| 113 | Norleucyl (-Nle-) |
| 114 | Asparagyl (-N-, -Asn-) |

THE UNIT OF MASS DIFFERENCE IS Da.

TABLE 4

| MASS | |
|---|---|
| DIFFERENCE | KIND OF MODIFICATION |
| 114 | t-amyloxycarbonyl (Aoc) |
| 114 | Ornithyl (-Orn-) |
| 115 | Proline (P, Pro) |
| 115 | Aspartyl (-D-, -Asp-) |
| 117 | Succinyl |
| 117 | Valine (V, Val) |
| 117 | Hydroxybenzotriazole ester (HOBt) |
| 118 | Dimethylbenzyl (diMeBzl) |
| 119 | Threonine (T, Thr) |
| 119 | Cysteinylation |
| 120 | Benzyloxymethyl (Bom) |
| 120 | p-methoxybenzyl (Mob, Mbzl) |
| 121 | 4-Nitrophenyl, p-Nitrophenyl (ONp) |
| 121 | Cysteine (C, Cys) |
| 125 | Chlorobenzyl (ClBzl) |
| 126 | Iodination (of Histidine[C4] or Tyrosine[C3]) |
| 128 | Glutamyl (-Q-, -Gln-) |
| 128 | Lysyl (-K-, -Lys-) |
| 129 | Glutamyl (-E-, -Glu-) |
| 129 | O-Methyl Aspartamyl |
| 130 | N alpha -(gamma-Glutamyl)-Glu |
| 131 | Norleucine (Nle) |
| 131 | Hydroxyproline (Hyp) |
| 131 | Isoleucine (I, Ile) |
| 131 | Leucine (L, Leu) |
| 131 | Methionyl (-M-, -Met-) |
| 131 | Hydroxy Aspartamyl |
| 131 | bb-dimethyl Cystenyl |
| 132 | Asparagine (N, Asn) |
| 132 | Pentoses (Ara, Rib, Xyl) |
| 133 | Aspartic Acid (D, Asp) |
| 134 | Benzyloxycarbonyl (Z) |
| 134 | Adamantyl (Ada) |
| 135 | p-Nitrobenzyl ester (ONb) |
| 137 | Histidyl (-H-, -His-) |
| 142 | N-methyl Glutamyl |
| 142 | N-methyl Lysyl |
| 143 | O-methyl Glutamyl |
| 144 | Hydroxy Lysyl (-Hyl-) |
| 145 | Methyl Methionyl |
| 146 | Glutamine (Q, Gln) |
| 146 | Deoxyhexoses (Fuc, Rha) |
| 146 | Lysine (K, Lys) |
| 146 | Pentosyl |
| 146 | Aminoethyl Cysteinyl (AECys) |
| 147 | 4-Glycosyloxy- (pentosyl,C5) (of Proline) |
| 147 | Glutamic Acid (E, Glu) |
| 147 | Phenylalanyl- (-F-, -Phe-) |
| 147 | Methionyl Sulfoxide |
| 148 | Pyridyl Alanyl |

THE UNIT OF MASS DIFFERENCE IS Da.

TABLE 5

| MASS | |
|---|---|
| DIFFERENCE | KIND OF MODIFICATION |
| 149 | 2-Nitrobenzoyl (NBz) |
| 149 | Methionine (M, Met) |
| 149 | Fluorophenylalanyl |
| 150 | Dimethoxybenzyl Trp |
| 153 | 2-Nitrophenylsulphenyl (Nps) |
| 154 | 4-Toluenesulphonyl (Tosyl, Tos) |
| 154 | 3-nitro-2-pyridinesulfenyl (Npys) |
| 155 | Histidine (H, His) |
| 156 | 3,5-Dibromination (of Tyrosine with ⁷⁹Br) |
| 156 | Arginyl (-R-, -Arg-) |
| 157 | Citrulline |
| 158 | 3,5-Dibromination (of Tyrosine with mixture of |
| | ⁷⁹Br and ⁸¹Br) |
| 159 | Dichlorobenzyl (Dcb) |
| 160 | 3,5-Dibromination (of Tyrosine with ⁸¹Br) |
| 160 | Carboxyamidomethyl Cystenyl |
| 161 | Hexosamines (GalN, GlcN) |
| 161 | Carboxymethyl cysteine (Cmc) |
| 161 | Carboxymethyl Cystenyl |
| 161 | Methylphenylalanyl |
| 162 | Inositol |
| 162 | N-Glucosyl (N terminus or N epsilon of Lysine) |
| | (Aminoketose) |
| 162 | O-Glycosyl- (to Serine or Threonine) |
| 162 | Linker attached to peptide in Fmoc peptide synthesis |
| 162 | Hexoses (Fru, Gal, Glc, Man) |
| 163 | Tyrosinyl (-Y-, -Tyr-) |
| 163 | MethionylSulphone |
| 165 | Phenylalanine (F, Phe) |
| 166 | 2,4-dinitrophenyl (Dnp) |
| 166 | Pentaflourophenyl (Pfp) |
| 166 | Diphenylmethyl (Dpm) |
| 167 | Phospho Seryl |
| 169 | 2-Chlorobenzyloxycarbonyl (ClZ) |
| 169 | Napthyl acetyl |
| 170 | N-acetyl Lysyl |
| 170 | N-methyl Arginyl |
| 172 | Ethanedithiol/TFA cyclic adduct |
| 173 | Carboxy Glutamyl (Gla) |
| 174 | Arginine (R, Arg) |
| 174 | Acetamidomethyl Cystenyl |
| 174 | Acrylamidyl Cystenyl |
| 176 | N-Glucuronyl (N terminus) |
| 117 | delta-Glycosyloxy- (of Lysine) or beta-Glycosyloxy- |
| | (of Phenylalanine or Tyrosine) |
| 177 | 4-Glycosyloxy- (hexosyl,C6) (of Proline) |
| 177 | Benzyl Seryl |
| 177 | N-methyl Tyrosinyl |
| 178 | a-N-Gluconoylation (His Tagged proteins) |
| 179 | p-Nitrobenzyloxycarbonyl (4Nz) |
| 179 | 2,4,5-Trichlorophenyl |

THE UNIT OF MASS DIFFERENCE IS Da.

TABLE 6

| MASS | |
|---|---|
| DIFFERENCE | KIND OF MODIFICATION |
| 180 | 2,4,6-trimethyloxybenzyl (Tmob) |
| 180 | Xanthyl (Xan) |
| 181 | Phospho Threonyl |
| 181 | Tyrosine (Y, Tyr) |
| 182 | Chlorophenylalanyl |
| 182 | Mesitylene-2-sulfonyl (Mts) |
| 183 | AEBSF |
| 184 | Isopropyl Lysyl |
| 186 | Tryptophanyl (-W-, -Trp-) |
| 186 | Carboxymethyl Lysyl |
| 188 | N-Lipoyl- (on Lysine) |
| 190 | Matrix alpha cyano MH+ |
| 191 | Benzyl Threonyl |
| 193 | Benzyl Cystenyl |
| 197 | Napthyl Alanyl |
| 198 | Succinyl Aspartamyl |
| 201 | HMP (hydroxymethylphenyl)/TFA adduct |
| 203 | N-acetylhexosamines (GalNAc, GlcNAc) |
| 204 | Tryptophan (W, Trp) |
| 204 | Cystine ((Cys)₂) |
| 204 | Farnesylation |
| 206 | S-Farnesyl- |
| 206 | Myristoylation-4H (2 double bonds) |
| 208 | Myristoleylation (myristoyl with one double bond) |
| 208 | Pyridylethyl Cystenyl |
| 210 | Myristoylation |
| 212 | 4-Methoxy-2,3,6-trimethylbenzenesulfonyl (Mtr) |
| 213 | 2-Bromobenzyloxycarbonyl (BrZ) |
| 214 | Formyl Tryptophanyl |
| 219 | Benzyl Glutamyl |
| 219 | Anisole Adducted Glutamyl |
| 222 | 9-Fluorenylmethyloxycarbonyl (Fmoc) |
| 222 | S-cystenyl Cystenyl |
| 226 | Biotinylation (amide bond to lysine) |
| 226 | Dimethoxybenzhydryl (Mbh) |
| 229 | N-Pyridoxyl (on Lysine) |
| 231 | Pyridoxal phosphate (Schiff Base formed to lysine) |
| 233 | Dansyl (Dns) |
| 233 | Nicotinyl Lysyl |
| 238 | 2-(p-biphenyl)isopropyl-oxycarbonyl (Bpoc) |
| 238 | Palmitoylation |
| 242 | Triphenylmethyl (Trityl, Trt) |
| 243 | Tyrosinyl Sulphate |
| 243 | Phospho Tyrosinyl |
| 252 | Pbf (pentamethyldihydrobenzofuransulfonyl) |
| 252 | 3,5-Diiodination (of Tyrosine) |
| 258 | a-N-6-Phosphogluconoylation (His Tagged proteins) |
| 259 | N alpha-(gamma-Glutamyl)-Glu2 |
| 266 | O-GlcNAc-1-phosphorylation (of Serine) |
| 266 | Stearoylation |

THE UNIT OF MASS DIFFERENCE IS Da.

TABLE 7

| | |
|---|---|
| MASS | |
| DIFFERENCE | KIND OF MODIFICATION |

| | |
|---|---|
| 266 | Pmc (2,2,5,7,8-Pentamethylchroman-6-sulphonyl) |
| 272 | Geranylgeranylation |
| 272 | Monomethoxytrityl |
| 276 | S-Geranylgeranyl |
| 289 | 5′phos dCytidinyl |
| 289 | iodo Tyrosinyl |
| 290 | Aldohexosyl Lysyl |
| 291 | Sialyl |
| 291 | N-acetylneuraminic acid (Sialic acid, NeuAc, NANA, |
| | SA) |
| 304 | 5′phos dThymidinyl |
| 305 | 5′phos Cytidinyl |
| 305 | Glutathionation |
| 306 | O-Uridinylylation (of Tyrosine) |
| 306 | 5′phos Uridinyl |
| 307 | N-glycolneuraminic acid (NeuGc) |
| 307 | S-farnesyl Cystenyl |
| 313 | 5′phos dAdenosyl |
| 324 | O-pantetheinephosphorylation (of Serine) |
| 327 | SucPhencarb Lysyl |
| 329 | 5′phos dGuanosyl |
| 329 | 5′phos Adenosinyl |
| 329 | O-5′-Adenosylation (of Tyrosine) |
| 339 | 4′-Phosphopantetheine |
| 342 | S-palmityl Cystenyl |
| 345 | 5′phos Guanosyl |
| 354 | Biotinyl Lysyl |
| 359 | Fluorescein labelling of peptide N-terminal using NHS |
| | ester |
| 365 | Hex-HexNAc |
| 388 | N alpha-(gamma-Glutamyl)-Glu3 |
| 391 | Dioctyl Phthalate |
| 395 | PMC Lysyl |
| 409 | Aedans Cystenyl |
| 413 | Dioctyl Phthalate Sodium Adduct |
| 415 | di-iodo Tyrosinyl |
| 423 | PMC Arginyl |
| 454 | S-Coenzyme A |
| 457 | AMP Lysyl |
| 470 | 3,5,3′-Triiodothyronine (from Tyrosine) |
| 524 | S-(sn-1-Dipalmitoyl-glyceryl)- (on Cysteine) |
| 541 | S-(ADP-ribosyl)- (on Cysteine) |
| 541 | N-(ADP-ribosyl)- (on Arginine) |
| 541 | O-ADP-ribosylation (on Glutamate or C terminus) |
| 541 | ADP-rybosylation (from NAD) |
| 587 | S-Phycocyanobilin (on Cysteine) |
| 617 | S-Heme (on Cysteine) |
| 648 | N theta- (ADP-ribosyl) diphthamide (of Histidine) |
| 657 | NeuAc-Hex-HexNAc |
| 783 | O-8 alpha-Flavin [FAD])- (of Tyrosine) |
| 784 | S-(6-Flavin [FAD])- (on Cysteine) |
| 784 | N theta and N pi-(8alpha-Flavin) (on Histidine) |

THE UNIT OF MASS DIFFERENCE IS Da.

TABLE 8
MODIFICATIONS FREQUENTLY OCCURRING
ON NATURAL PROTEINS

| | CORRESPONDING | |
|---|---|---|
| MASS | AMINO | KIND OF |
| DIFFERENCE | ACID RESIDUE | MODIFICATION |
| −17 | N terminus | N-pyrrolidone |
| | | carboxylation |
| −1 | C-treminus | amide formation |
| 1 | N, Q | deamination to D and E |
| 14 | N terminus, C terminus, | methylation |
| | K, S, T, N, R | |
| 16 | K, W, P, D, M^{†} | ^{†}hydroxylation, oxidation |
| 28 | K, R, N terminus^{†} | N,N dimethylation, |
| | | ^{†}formylation |
| 32 | M | oxidation |
| 42 | N terminus^{†}, | ^{†}acetylation, |
| | S^{†}, T^{†}, Y^{†}, K^{†‡} | ^{‡}N-trimethylation |
| 48 | M | selenomethinine (from M) |
| 68 | Y | 3,5-dichlorination |
| | | (with ³⁵Cl) |
| 80 | S^{†}, T^{†}, Y^{†‡}, D^{†}, K^{†}, F* | ^{†}phosphorylation, |
| | | ^{‡}sulphation |
| | | *L-o-bromination |
| | | (with ⁸¹Br) |
| 126 | H, Y | iodination |
| 156 | Y | 3,5-dibromination |
| | | (with ⁷⁹Br) |
| 158 | Y | 3,5-dibromination |
| | | (with mixture of |
| | | ⁷⁹Br and ⁸¹Br) |
| 160 | Y | 3,5-dibromination |
| | | (with ⁸¹Br) |
| 208 | N terminus | myristoleylation |
| | | (myristoyl with |
| | | one double bond) |
| 252 | Y | 3,5-diiodination |
| 470 | Y | 3,5,3′-triiodothyronine |
| | | (from Y) |
| 596 | Y | 3,5,3′,5′-tetraiodothyronine |
| | | (from Y) |
| 617 | C | S-heme |

 THE UNIT OF MASS DIFFERENCE IS Da.

Back in FIG. 5, in calculation of the mass shift from the undetected peptide in Step 116, attention is given to the undetected peptides of identified hypothetical gene. The mass of each undetected peptide is shifted by the value shown in Table 1 (S116). In examination of corresponding unidentified peak in Step 117, it is judged whether there is an unidentified peak at the position corresponding to the mass after shift in Step 116 (S117). When the corresponding unidentified peak is found, the peak may be a peptide fragment modified on the side chain. The mass difference indicates the kind of corresponding modification.

As shown in Table 1, each modification on a side chain occurs specifically to its particular amino acid residue. Thus, if an amino acid residue that can accept the modification suggested in Steps 116 to 117 is not found in the fragment, the peak is highly likely a noise. Then, it is judged whether an amino acid residue capable of accepting the suggested modification is actually present in the hypothetical peptide fragment, with reference to the amino acid sequence of the undetected peptide selected in Step 116. If it is absent, the possibility of the modification is denied.

By the steps above, it is possible to suggest the possibility of post-translational modification. By using the method according to the present embodiment, it is possible to obtain information about the modification on the side chains and terminals of the sample protein easily by using unidentified peaks.

After Step 117 in the present embodiment, the presence of post-translational modification may be checked additionally, for example, by performing MS/MS measurement in the procedure of Step 118. By performing MS/MS measurement of corresponding fragments, it is judged whether the unidentified peaks, i.e., possible peptide fragments having suggested modification, have the amino acid sequence identical with that of the undetected peptide under consideration. The peak under study is regarded as a noise if there is no consistency between them.

In addition, in Step 118, it is possible to determine whether the unidentified peak under examination is a noise derived from a protein other than the analyte protein or a peak derived from other trypsin-digested fragments from the analyte protein, by using de novo sequencing by MS/MS measurement. It is thus possible to improve the analytical quality more.

### THIRD EMBODIMENT

The present embodiment relates to the analysis of amino acid substitution (S105) in FIG. 2 in the analysis of unidentified peaks (S103) of FIG. 1. The analysis is made, for example, on the peaks remaining unidentified after analysis in Steps 101, 102, and 104. It is judged whether each trypsin-digested fragment has single amino acid substitution, and the kind of substitution is analyzed.

Table 9 is a table showing the increase in mass when an amino acid residue is present in the peptide fragment of sample protein. In Table 9, the mass corresponding to an amino acid residue X is shown as m_{X}. Also in Table 9, each amino acid residue is expressed with a single character. C*₁, C*₂, C*₃, C*₄, and C*₅ represent derivatives of a cysteine residue modified by alkylation, respectively carboxyamidomethylcysteine, carboxymethylcysteine, pyridylethylcysteine, aminoethylcysteine, and acrylamide cysteine.

TABLE 9

| X | mₓ | X | mₓ | X | mₓ | X | mₓ |
|---|---|---|---|---|---|---|---|
| G | 57.02 | C | 103.00 | Q | 128.16 | W | 186.08 |
| A | 71.04 | L or I | 113.08 | M | 131.04 | C*₁ | 160.03 |
| S | 87.03 | D | 115.03 | H | 137.06 | C*₂ | 161.01 |
| P | 97.05 | N | 114.04 | F | 147.07 | C*₃ | 208.07 |
| V | 99.07 | E | 129.04 | Y | 163.06 | C*₄ | 146.05 |
| T | 101.05 | K | 128.10 | R | 156.10 | C*₅ | 174.05 |

 THE UNIT OF MASS DIFFERENCE IS Da.

When an amino acid residue X is substituted with another amino acid residue Y in a peptide fragment, the mass difference then is calculated by:

−m_{X}+m_{Y}=Δm_{XY}.

Table 10 is a table summarizing the mass differences Δm_{XY} that may occur by amino acid substitutions. In Table 10, Δm_{XY} is expressed as “d”. Also in Table 10, amino acid substitution between amino acid residues X and Y (from X to Y or from Y to X) is shown with “XY”. Each amino acid residue is indicated by a single character. The character “XY” with solid underline means that the minimum number of substitution bases needed for the base substitution realizing the amino acid substitution is 1; that without solid line, 2; and that with broken line, 3. As for the numbers in the Table, a positive number indicates the mass difference by rightward substitution from X to Y, while a negative number, leftward substitution from Y to X. As for substitutions involving K and R, cleavage sites of trypsin digestion, are shown in parenthesis in the Table.

TABLE 10

| | KIND OF AMINO |
|---|---|
| d | ACID SUBSTITUTION |
| ±1 | IN, ND, QE, |
| | C*₄F, LN, (KE), |
| ±2 | PV, VT, TC, |
| | LD, ID, EM, C*₂Y |
| ±3 | QM, C*₁Y, (KM) |
| ±4 | PT, VC, (RC*₁) |
| ±5 | (RC*₂) |
| ±6 | [symbol] |
| ±7 | (RY) |
| ±8 | EH |
| ±9 | QH, HC*₄, (FR), (KH) |
| ±10 | SP, CL, CI, HF, (C*₄R) |
| ±11 | CN, YC*₅, |
| ±12 | TI, TL, SV, CD, C*₅W |
| ±13 | TN, DQ, FC*₁, (DK) |
| ±14 | GA, ST, VL, VI, TD, |
| | DE, NQ, FC*₂, (NK) |
| ±15 | LQ, VN, IQ, NE, |
| | MC*₄, (IK), (LK) |
| ±16 | AS, SC, PL, VD, FY |
| | [symbol] |
| ±17 | [symbol] |
| ±18 | PD, LM, IM, EF |
| | [symbol] |
| ±19 | [symbol] |
| ±22 | DH, WC*₃ |
| ±23 | NH, YW, HC*₁ |
| ±24 | LH, IH, HC*₂ |
| ±25 | [symbol] |
| ±26 | [symbol] |
| ±27 | SN, FC*₅, TQ, (ER), (TK) |
| ±28 | AV, KR, SD, TE, CM, (QR) |
| ±29 | [symbol] |
| ±30 | MC*₂, GS, AT, VE, TM, (RW) |
| ±31 | [symbol] |
| ±32 | VM, AC, PE, DF, NC*_{4,} |
| | [symbol] |
| ±33 | NF, IC*₄, LC*₄, QC*₂, (KC*₂) |
| ±34 | IF, LF, CH, EY, PM, |
| ±35 | QY, (KY) |
| ±36 | TH |
| ±37 | HC*₅ |
| ±38 | VH |
| ±39 | FW |
| ±40 | PH, C*₄W, GP |
| ±41 | SQ, (DR), (SK) |
| ±42 | GV, AI, AL, SE, (NR) |
| ±43 | AN, MC*₅, (LR), (IR) |
| ±44 | AD, CF, GT, SM |
| ±45 | [symbol] |
| ±46 | GC, DC*₂, NC*₁, |
| | [symbol] |
| ±47 | IC*₁, LC*₁, NC*₂, VC*₄ |
| ±48 | DY, VF, IC*₂, LC*₂ |
| ±49 | [symbol] |
| ±50 | IY, LY, PF, SH |
| ±52 | (RC*₃) |
| ±53 | (CR) |
| ±55 | MW, (TR) |
| ±56 | GI, GL |
| ±57 | AQ, EW, GN, (AK), (VR) |
| ±58 | AE, GD, QW, (KW) |
| ±59 | SC*₄, DC*₅, TC*₁, (PR) |
| ±60 | CY, SF, AM, NC*₅, TC*₂ |
| ±61 | FC*₃, IC*₅, LC*₅, VC*₁, |
| ±62 | TY, VC*₂ |
| ±63 | PC*₁ |
| ±64 | PC*₂, VY |
| ±66 | AH, PY |
| ±69 | (SR) |
| ±71 | [symbol] |
| ±72 | GE, NW |
| ±73 | [symbol] |
| ±74 | SC*₂, GM |
| ±75 | AC*₄, VC*₅ |
| ±76 | SY, AF |
| ±77 | [symbol] |
| ±79 | [symbol] |
| ±80 | [symbol] |
| ±83 | CW |
| ±85 | TW, (AR) |
| ±87 | SC*₅, VW |
| ±89 | GC*₄, AC*₁, PW, |
| ±90 | AC*₂, GF |
| ±92 | AY |
| ±93 | DC*₃ |
| ±94 | NC*₃ |
| ±95 | IC*₅, LC*₅ |
| ±99 | SW, (GR) |
| ±103 | GC*₁, AC*₅ |
| ±104 | GC*₂ |
| ±106 | GY |
| ±107 | TC*₃ |
| ±109 | VC*₃ |
| ±111 | PC*₃ |
| ±115 | AW |
| ±117 | GC*₅ |
| ±121 | SC*₃ |
| ±129 | GW |
| ±137 | AC*₃ |
| ±151 | GC*₃ |

 THE UNIT OF MASS DIFFERENCE IS Da.

The median value of the mass of observed unidentified peaks is represented by mₑₓ, and the mass of an undetected peptide derived from identified gene, by mₜₕ. It is analyzed whether an unidentified peak is generated by single amino acid substitution. When a protein is fragmented by using trypsin, the peptide bond immediately after K or R is cleaved. Thus, amino acid substitution involving K or R, if it occurs, leads to change in the mass pattern of digested fragments.

In the present embodiment, substitutions involving K and R and the other substitutions are analyzed separately. Specifically, substitutions are analyzed separately in the following three cases:

(I) where there is substitution not involving K and R or substitution between K and R,
(II) where a new cleavage site is formed, as an amino acid residue other than K and R is substituted with K or R, and
(III) where a cleavage site disappears as K or R is substituted with another amino acid residue.

The order of analysis among the cases (I) to (III) is not particularly limited, but the analysis may be performed, for example, in the order of (I), (II), and (III). Hereinafter, each of the cases (I) to (III) will be described.

In the present embodiment, a peak having a median value of mass of m will be called peak m. A peptide fragment having a mass of m′ will be called peptide fragment m′.

### (I) Substitution not Involving K and R or Between K and R

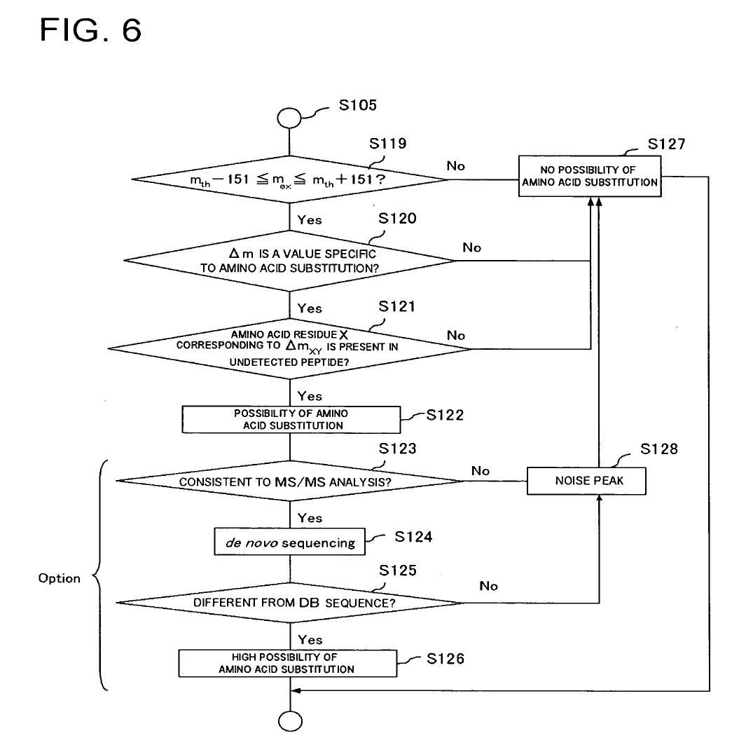

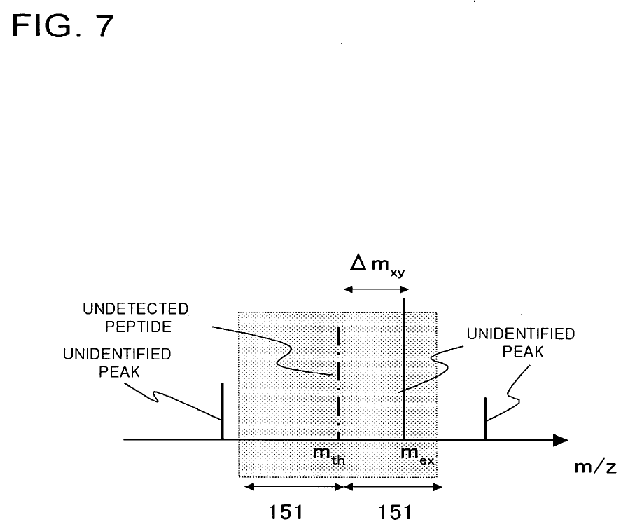

FIG. 6 is a flow chart showing the procedure of analyzing the presence and the kind of amino acid substitution when substitution not involving K and R or between K and R occurs. FIG. 7 is a chart explaining the analytical method shown in FIG. 6. First in FIG. 6, an unidentified peak mₑₓ having a mass mₑₓ as a center of the peak present within the range of ±151 from the peak mₜₕ of an undetected peptide is extracted (S119). When the unidentified peak is extracted (Yes in S119), it is judged whether the difference between the mass mₑₓ of the extracted unidentified peak and the mass mₜₕ of the undetected peptide,

Δm=mₑₓ−mₜₕ,

corresponds to the value of mass change that may occur by amino acid substitution (S120). If Δm is possibly caused by amino acid substitution (Yes in S120), it is judged whether the amino acid residue X corresponding to Δm_{XY} is included in the undetected peptide (S121). Presence of the amino acid residue X in the undetected peptide (Yes in Step 121) leads to an analytical result indicating the possibility of single amino acid substitution (S122). On the other hand, No in any one of Steps 119 to 121 leads to an analytical result indicating that there is no single amino acid substitution (S127), and the procedure advances to the next analysis.

When an analytical result indicating the possibility of single amino acid substitution is obtained (S122), analysis in the following steps may be performed additionally as needed. The peptide fragment corresponding to the unidentified peak mₑₓ is first subjected to MS/MS measurement, and the consistency of the result is evaluated (S123). Specifically in Step 123, it is judged whether the unidentified peak mₑₓ is a peptide in the same region as the undetected peptide mₜₕ. If it is observed to be a peptide in the same region with the undetected peptide mₜₕ (Yes in S123), the peptide may be subjected to de novo sequencing (S124). It is judged whether there is a difference by comparing the result with amino acid sequences stored in database (S125). If the partial sequence of the peptide is identical with the amino acid sequence stored in database (Yes in S125), the analytical result indicates the high possibility of amino acid substitution (S126). On the other hand, if the judgment in Step 125 or Step 126 is “No”, the unidentified peak mₑₓ is a noise peak (S128), and the analytical result obtained indicates that it is not single amino acid substitution (S127).

Hereinafter, each step in FIG. 6 will be described in more detail.

In Step 119, unidentified peaks mₑₓ contained in the range of ±151 from the undetected peptide mₜₕ is extracted. The maximum mass difference |Δm_{XY}| that may possibly occur by amino acid substitution is 151, by substitution between C*₃ (pyridylethylcysteine) and G (glycine). In other words, no mass change greater then ±151 occurs by single amino acid substitution. Thus, it is sufficient to examine the region of ±151 from the mass of undetected peptide derived from the identified hypothetical gene, for evaluation of the peak shift by single amino acid substitution. Unidentified peaks present in the region for each of the undetected peptide are selected, and analyzed in Step 120.

In the step above, the range of mass difference is set, including the case in which masses of cysteine residues is derivatized, considering alkylation of cysteine residues for prevention of recombination after cleavage of disulfide bond between cysteine derivative residues by reduction. Specifically in Table 10, shown are the cases of carboxyamidomethylcysteine (C*₁) when monoiodoacetamide is used as the alkylatating reagent, carboxymethylcysteine (C*₂) when monoiodoacetic acid is used, pyridylethylcysteine (C*₃) when 4-vinylpyridine is used, aminoethylcysteine (C*₄) when ethyleneimine is used, and acrylamidocysteine (C*₅) when acrylamide is used. Thus in the present embodiment, although the deviation |Δm_{XY}| in mass from mₜₕ is assumed to be in the region of ±151 from the mass of undetected peptide derived from the hypothetical gene, the maximum deviation |Δm_{XY}| in mass from mₜₕ in Step 119 may be set properly according to the considered modification pattern such as alkylation to be considered, and is not limited to the range of ±151.

If the analyte protein is highly unlikely to contain a cysteine residue, alkylation may not be considered. In such a case, the maximum mass difference |Δm_{XY}| caused by amino acid substitution is 129 of substitution between W (tryptophan) and G (glycine). Because there is no mass change greater than ±129 by single amino acid substitution, it is sufficient to consider the range of ±129 from the mass of the identified hypothetical gene-derive undetected fragment, in examination of the peak shift by single amino acid substitution.

In Step 120, it is examined whether the mass difference between mass mₑₓ of the unidentified peak mₑₓ and the undetected peptide mₜₕ is compatible with the amino acid substitution. It is judged whether there is m_{XY} satisfying the equation:

Δm=mₑₓ−mₜₕ=Δm_{XY},

by calculating Δm=mₑₓ−mₜₕ and using the information in Table 10. In this way, it is possible to select only the unidentified peaks corresponding to the amino acid substitutions described in Table 10. It is also possible to select unidentified peaks of which the mass is possibly changed from mₜₕ to mₑₓ by amino acid substitution and to suggest the kind of possible amino acid substitution from the value of Δm.

In Step 121, it is judged whether there is an amino acid residue X in the peptide corresponding to Δm_{XY}. It is because the unidentified peak mₑₓ may possibly be not the peak from the sample protein but a noise peak accidentally generated. In such a case, it is occasionally possible to eliminate such a peak by referring to the amino acid sequence of the fragment.

Because Δm_{XY} is a mass change caused by the amino acid substitution of X with Y, it is first judged, by referring to the amino acid sequence for the undetected peptide mₜₕ, whether the amino acid residue X is actually present in the sequence. If there is absent (No in S121), the peak mₑₓ is obviously not a peak generated by amino acid substitution of the identified protein.

In Step 123, consistency check is performed by MS/MS measurement for verification of the possibility of the amino acid substitution suggested in Step 122. It is possible to obtain information directly reflecting the amino acid sequence to a greater degree by performing MS/MS measurement. Thus, it is possible to determine whether the unidentified peak mₑₓ is a peak generated from the sample protein or an accidental noise. It is thus possible to improve the accuracy of analysis.

After the MS/MS measurement, it is judged whether the unidentified peak mₑₓ is a peptide in the same region with the undetected peptide mₜₕ. If it is confirmed, the result strongly suggests the possibility of substitution of the amino acid residue X, on the basis of two grounds that (IA) mₑₓ and mₜₕ correspond to peptides in the same region of “the same protein”, and (IB) mₑₓ is shifted from mₜₕ by a particular mass equivalent to amino acid substitution from X to Y.

In Step 124, if the partial sequence of peptide fragment mₑₓ is available by de novo sequencing, the partial sequence is compared with the amino acid sequence of the undetected peptide mₜₕ under study. In this way, it is possible to confirm the amino acid substitution more directly and thus, to perform more accurate analysis.

(II) Substitution of K or R with an Amino Acid Residue Other than K and R, Forming a Cleavage Site

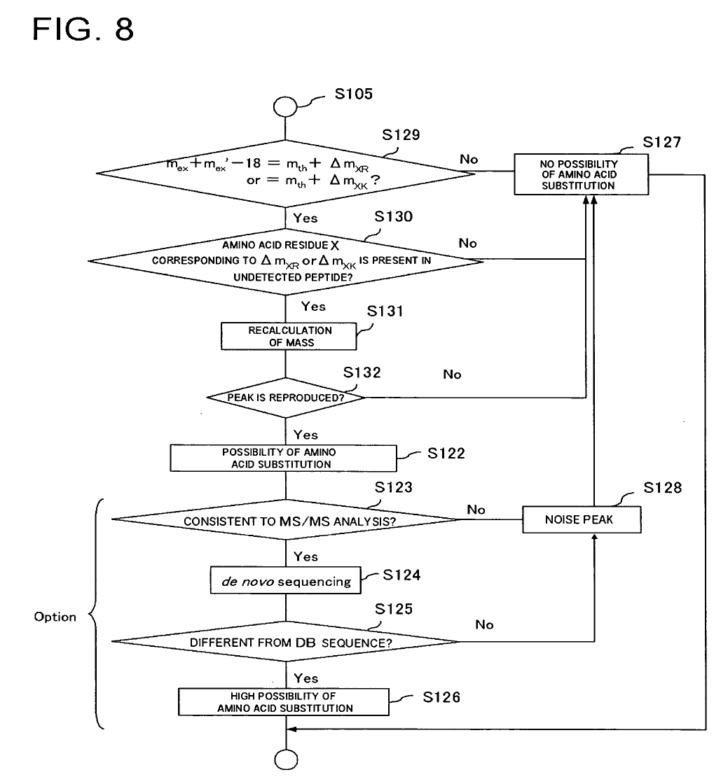

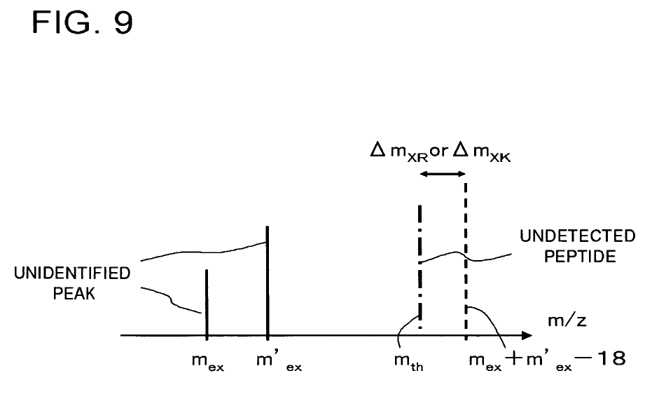

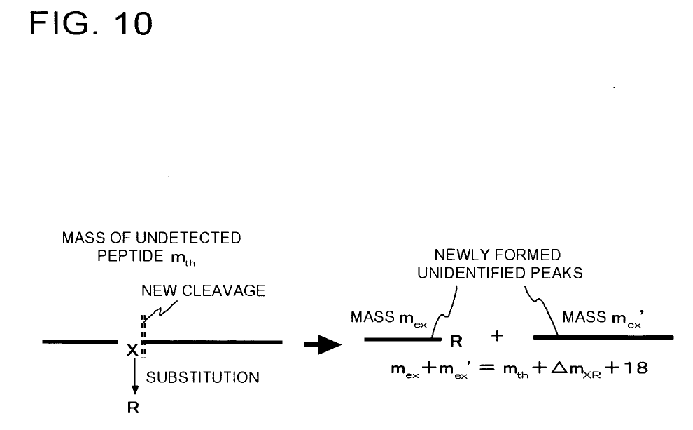

FIG. 8 is a flow chart showing the procedure of analyzing whether a cleavage site disappears by substitution of K and R with another amino acid residue. FIGS. 9 and 10 are charts explaining the analytical method by using the procedure shown in FIG. 8.

FIG. 10 is a schematic chart showing substitution state of an amino acid residue X with a residue R. When an existing amino acid residue other than R and K is substituted with R or K, a new trypsin-cleavage site is formed there. Thus, there is a change in the pattern of the fragments generated by trypsin digestion. Although substitution with R is shown in FIG. 10, substitution with K also gives the same results. The substitution results in generation of two unidentified peaks, mₑₓ and mₑₓ′.

In such a case, the mass difference between the sum in mass of two fragments, mₑₓ and mₑₓ′, generated by trypsin cleavage and the mass of the original fragment becomes m_{XR}+18. The mass difference caused by substitution with K is m_{XK}+18. The number “18” is the mass change caused by dehydration during peptide bond formation.

In FIG. 8, first for retrieval of the unidentified peaks newly generated by substitution with K or R, the total mass of any pair of two unidentified peaks is calculated, and it is judged (S129) whether there is a combination of the unidentified peaks mₑₓ and mₑₓ′ satisfying the following Formula:

mₑₓ+mₑₓ′=mₜₕ+Δm_{XR}+18 (3)′ or

mₑₓ+mₑₓ′=mₜₕ+Δm_{XK}+18 (4)′

If there is no pair of unidentified peaks, mₑₓ and mₑₓ′, satisfying any one of the Formulae (3)′ and (4)′ (No in S129), it is judged that the kind of amino acid substitution is absent (S127).

If there is a combination of mₑₓ and mₑₓ′ satisfying any one of the Formulae (3)′ and (4)′, it is judged then whether there is amino acid residue X in the corresponding undetected peptide mₜₕ (S130). If absent (No in S130), the unidentified peaks, mₑₓ and mₑₓ′, are both judged as noises (S127).

On the other hand, if there is an amino acid residue X satisfying the Formula (3)′ or (4)′ (Yes in S130), it is judged whether the undetected peptide mₜₕ is compatible with the mass of the fragment generated by cleavage immediately after X. Specifically, the mass of the fragment generated by hypothetical cleavage of the undetected peptide mₜₕ at the site immediately after X is recalculated (S131), and the reproducibility is evaluated by determining the consistency between the mass obtained and the mass of the two unidentified peak under study (S132). All amino acid residues X contained are checked in Step 132.

For example as shown in FIG. 10, if mₑₓ+mₑₓ′=mₜₕ+Δm_{XR}+18, the undetected peptide mₜₕ is cleaved at a site immediately after the amino acid residue X; the terminal of X is substituted with R; and the mass of the two fragments is calculated. The masses are identical with the mass of the two unidentified peaks under study, mₑₓ and mₑₓ′ (Yes in S132), an analytical result suggesting the possibility of single amino acid substitution is obtained (S122). If mₑₓ+mₑₓ′=mₜₕ+Δm_{XK}+18, the undetected peptide mₜₕ is cleaved at a site immediately after the amino acid residue X, the terminal of X is substituted with K, the mass of the two fragments are calculated, and a similar analysis is preformed. If there is discrepancy in this stage (No in S132), the peptide peak is regarded as an accidental noise peak (S127).

If an analytical result suggesting the possibility of single amino acid substitution is obtained (Yes in S132), a consistency check may be performed then as needed by MS/MS measurement (S123), similarly to the case (I) described above. In this way, it is possible to obtain information directly reflecting the amino acid sequence to a greater degree similarly to the case (I). It is thus possible to determine whether the two undetected peaks under study are generated from the identified protein or accidental noises. It is thus possible to increase the accuracy of analysis more.

In Step 123, the unidentified ions under study, mₑₓ and mₑₓ′, may be subjected to fragmentation analysis by MS/MS measurement. It is possible in this way, to confirm the consistency as the entire or a partial peptide of the undetected peptide mₜₕ under study. If the consistency is confirmed, the possibility of substitution of amino acid residue X with R or K and new cleavage by trypsin is suggested far more strongly on the basis of the facts that

(IIA) mₑₓ and mₜₕ are peptides in the region common in “the same protein”,
(IIB) mₑₓ′ and mₜₕ are peptides in the region common in “the same protein”, and
(IIC) the sum of mₑₓ and mₑₓ′ is shifted from mₜₕ+18 by a mass corresponding to amino acid substitution from X to R or amino acid substitution from X to K.

It is also possible to evaluate entire or partial consistency of mₑₓ and mₑₓ′ with the undetected peptide mₜₕ by de novo sequencing. Specifically if partial amino acid sequences of the peptides mₑₓ and mₑₓ′ are obtained by de novo sequencing, it is judged whether the sequences are included in the amino acid sequence of the peptide mₜₕ under study.

If the consistency is not confirmed by the operations above, mₑₓ and mₑₓ′ are regarded as noise peaks (S128). It is judged that there is no amino acid substitution with K or R, and the procedure advances to the next analysis.

Although the method (II) was described above, taking trypsin cleavage of sample protein as an example, but the method (III) may be applicable to the case when other enzyme is used for cleavage. In such a case, it is judged whether there is substitution of the amino acid residue at the cleavage site with an amino acid residue not at the cleavage site, according to the following procedure. Namely, first among the hypothetical peptide fragments, unidentified peaks having a mass mₑₓ and a mass mₑₓ′ satisfying the following Formula (1) with respect to the mass mₜₕ of the undetected peptide not corresponding to the peak present in the mass spectrum are extracted. It is then judged whether an amino acid residue Y corresponding to Δm_{YX} in the following Formula (1) is present in the undetected peptide. Then, it is judged whether the unidentified peak corresponding to the mass of the hypothetical peptide fragments predicted to be generated by amino acid substitution is present in the mass spectrum of the analyte protein. If the unidentified peak is present, it may be judged that there is amino acid substitution.

mₑₓ+mₑₓ′−18=mₜₕ+Δm_{YX} (1)

(in Formula (1), Δm_{YX} represents a mass change when the amino acid residue X at the cleavage site is substituted with an amino acid residue Y not at the cleavage site mass change; and plurality of the amino acid residues X different in kind may be present).

In addition to the trypsin digestion, methods of cleaving a sample protein selectively at a predetermined site include the following methods. An example thereof is enzyme digestion by using another protease having specificity of cleavage site such as V8 protease cleaving the C-terminal side of glutamic acid, lysyl endopeptidase cleaving the C-terminal side of lysine residue, or endoprotease ASP-N cleaving the N-terminal side of aspartic acid or cysteine residue. Alternatively, a cleavage method by using a chemical reagent such as CNBr specific to the cleavage of C-terminal sided amide bond of methionine residue may also be used.

(III) Disappearance of Cleavage Site by Substitution of K or R with Another Amino Acid Residue

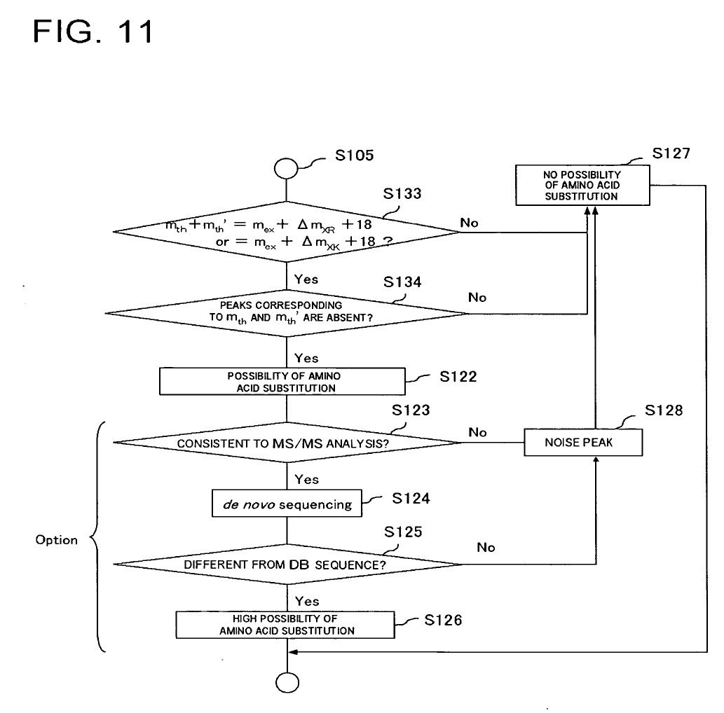

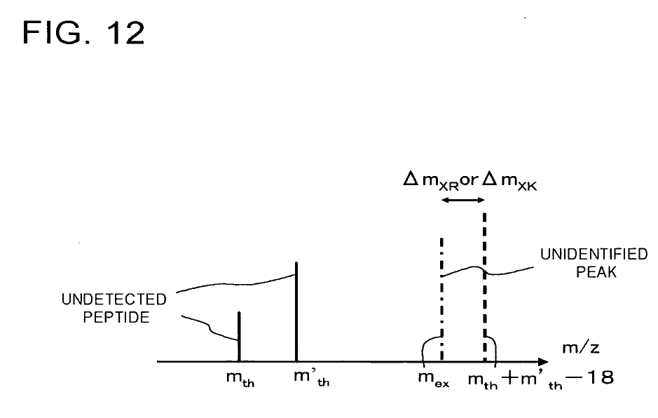

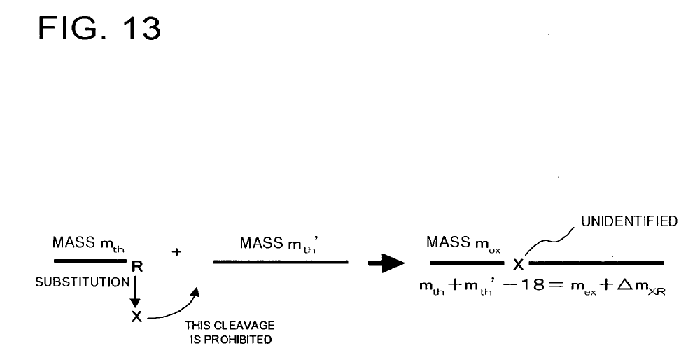

FIG. 11 is a flow chart showing the procedure of analyzing whether a cleavage site disappears by substitution of K or R with another amino acid residue. FIG. 12 is a chart explaining the analytical method using the procedure shown in FIG. 11. FIG. 13 is a schematic chart showing substitution of an amino acid residue R with X. Although the case where R is substituted is shown in FIG. 13, K may be substituted similarly.

When existing R or K is substituted with an amino acid residue other than R and K, trypsin cleavage at the position does not proceed, which leads to change in the mass distribution of the fragments generated by trypsin digestion and generation of unidentified peaks. The substitution results in generation of two undetected peptides, mₜₕ and mₜₕ′.

In such a case, the difference between the sum of the mass of two fragments possibly generated by trypsin digestion and the mass of observed peak is Δm_{RX}+18. The number “+18” is a value associated with the dehydration during peptide bond formation. The mass difference when K is substituted is Δm_{KX}+18.

In FIG. 11, first for retrieval of the unidentified peaks newly generated by substitution of K or R, undetected peptides present in the mass region lower than the mass mₑₓ of the unidentified peak are retrieved; the sum of the mass of the all neighboring undetected peptide pair, mₜₕ and mₜₕ′ in the amino acid sequences of the proteins present in the region is calculated; and it is judged (S133) whether there is an unidentified peak mₑₓ satisfying the Formula:

mₜₕ+mₜₕ′=mₑₓ+Δm_{XR}+18, or

mₜₕ+mₜₕ′=mₑₓ+Δm_{XK}+18.

If it is absent (No in S133), it is judged that such an amino acid substitution is absent (S127).

If there is an unidentified peak mₑₓ (Yes in S133), there should be no peak at the positions of mₜₕ and mₜₕ′ in the spectrum if there is no trypsin cleavage. It is then judged whether there is no peak at the positions of mₜₕ and mₜₕ′ in the mass spectrum of the peptide fragments of sample protein (S134). If these peaks still remain (No in S134), they are regarded as accidental noise peaks (S127).

If there is no peak (Yes in S134), it suggests the possibility of amino acid substitution of K or R (S122). In such a case, consistency check may be performed then as needed by MS/MS measurement (S123), similarly to the case (I) above. In this way, it is possible to obtain information directly reflecting the amino acid sequence to a greater degree, similarly to the cases (I) and (II). Thus, it is possible to determine whether the undetected peak under study is generated from the identified protein or an accidental noise. It is thus possible to increase the accuracy of analysis more.

Here, fragmentation analysis of the unidentified peak mₑₓ under study is performed by MS/MS measurement. The consistency between the undetected peptide mₜₕ under study and the undetected peptide mₜₕ′ is evaluated (S123). If the consistency is confirmed, it suggests substitution of an amino acid residue R or K with another amino acid and the absence of trypsin cleavage, based on the facts that:

(IIIA) mₑₓ and mₜₕ or mₑₓ and mₜₕ′ are peptides in the region common in “the same protein”,
(IIIB) it was actually possible to confirm absence of the trypsin cleavage by substitution of K or R, and
(IIIC) the value (mₜₕ+mₜₕ′−18) is shifted lower from mₑₓ by a mass difference equivalent to amino acid substitution from R to X or amino acid substitution from K to X.

The above (IIIA) may be confirmed by de novo sequencing (S124). If a partial amino acid sequence of mₑₓ is obtained, the partial amino acid sequence is compared with the amino acid sequences of the undetected peptides mₜₕ and mₜₕ′. It is judged whether the partial amino acid sequence of mₑₓ is included in at least one of the undetected peptides mₜₕ or mₜₕ′. It is possible to improve the reliability of the analytical results by confirmation by the method. In such a case, the de novo sequence including the substituted site may be also possibly obtained. If the consistency is not confirmed in the procedure above, the mₑₓ is regarded as a noise peak (S128).

Although the method (III) was described above, taking trypsin cleavage of sample protein as an example, but the method is applicable to the case when other enzyme is used for cleavage. In such a case, it is judged whether there is substitution of the amino acid residue at the cleavage site with an amino acid residue not at the cleavage site, according to the following procedure. That is, first among the hypothetical peptide fragments, unidentified peaks having a mass mₑₓ satisfying the following Formula (2) with respect to the neighboring undetected peptides having a mass mₜₕ and a mass mₜₕ′ in the sequence of the hypothetical peptide, from the undetected peptides not corresponding to the peaks present in the mass spectrum are extracted. Then, it is judged whether the peaks corresponding the undetected peptides having a mass mₜₕ and a mass mₜₕ′ are absent in the mass spectrum of protein. If the peak is absent, it is judged that amino acid substitution is present. For example, the method described in (II) may be used as the method of cleaving the sample protein selectively at a predetermined site.

mₜₕ+mₜₕ′−18=mₑₓ+Δm_{YX} (2)

(in Formula (2), Δm_{YX} represents a mass change when the amino acid residue Y not at the cleavage site is substituted with an amino acid residue X at the cleavage site; and the amino acid residue X at the cleavage site is restricted to the amino acid residue at the boundary of two of the undetected peptides).

By the analyses (I) to (III), it is possible to analyze the presence and the kind of single amino acid residue substitution cyclopaedically by using the unidentified peaks. Thus, it is possible to analyze the amino acid substitution from the hypothetical amino acid sequence described in database reliably and to obtain information on the primary structure of the analyte protein.

In the present embodiment, the amino acid substitution accompanied by the mass difference of same vale shown in Table 11 can occur also by the side-chain modification described in the second embodiment. Thus, such substitution may be discussed separately and individually. Table 11 is a table summarizing duplicated amino acid substitutions accompanied by a mass difference Δm (unit: Da) and modifications frequently occurring on natural proteins. Also in Table 11, an amino acid residue is expressed with a single character.

TABLE 11

| | MODIFICATION FREQUENTLY | |
|---|---|---|
| | OCCURRING ON NATURAL | |
| | PROTEINS (CORRESPONDING | AMINO ACID |
| Δm | AMINO ACID RESIDUE) | SUBSTITUTION |
| −17 | N-pyrrolidone carboxylation(N terminus) | [symbol] |
| −1 | amide formation(C-treminus) | NI, DN, EQ, |
| | | F C*₄, NL, (EK) |
| 1 | deamination to D and E (N, Q) | IN, ND, QE, |
| | | C*₄F, LN, (KE), |
| 14 | methylation | GA, ST, VL, VI, TD, |
| | (N terminus, C terminus, K, S, T, N, R) | DE, NQ, FC*₂, (NK) |
| 28 | N,N-dimethylation (K, R) | [symbol] |
| | formylation (N terminus) | (QR) |
| 42 | acetylation (N terminus, S, T, Y, K) | GV, AI, AL, SE, (NR) |
| | N-trimethylation (K) | |
| 48 | selenomethinine (from M) | DY, VF, IC*₂, LC*₂ |
| 80 | phosphorylation^{†} (O of S, T, Y, and D, | [symbol] |
| | N epsilon of K) sulphation^{‡} (of O of Y) | |
| | L-o-bromination* (of F with ⁸¹Br) | |

 THE UNIT OF MASS DIFFERENCE IS Da.

Analysis of the mass difference Δm shown in Table 11 is already completed before 102. When a mass difference described in Table 11 is detected in the stage of Step 102, the possibility of amino acid substitution accompanying the same mass difference is also analyzed additionally. If the selected modification is characteristic at the N terminal or C terminal, it is judged whether the fragment under study is indeed an N-terminal or C-terminal fragment by referring to database sequences. If it is not a terminal-derived fragment, the possibility is limited to amino acid substitution.

### FOURTH EMBODIMENT

The present embodiment relates to the procedure of the analyzing mutants of FIG. 2 (S106) in the analysis of unidentified peaks (S103) in FIG. 1. The analysis is performed, for example, on the peaks remaining unidentified after analyses in Steps 101 to 105. Specifically, it is analyzed whether there is difference between the splicing patterns described in database and the pattern of splicing occurring during expression of the sample protein and what the difference is if present. A change in splicing pattern inevitably leads to a change in the mass spectrum of the peptide fragments generated by trypsin digestion, and in the present embodiment, the change is analyzed by using unidentified peaks.

Typical states where the splicing pattern changes include, for example,

case 1: the case where a new selective splicing by using a region called intron in database occurs,

case 2: the case where an error is included in part of the predicted exon described in database,

case 3: the case where abnormal splicing occurs, and the like.

Although mutation of the base sequence in boundary between exon and intron and malfunction of the protein responsible for the splicing mechanism are considered to be the causes, it is difficult fundamentally to predict which kind of mature mRNA is produced. Thus, the amino acid sequences of the polypeptides hypothetically translated in three different reading frames from all undetected exon and intron regions are determined, and the relationship thereof with the unidentified peaks are investigated.

After mapping the peptide fragments detected by mass spectrometry of sample protein on the hypothetical amino acid sequence described in database and on the base sequence of the hypothetical gene, the corresponding base sequence regions are extracted. In the following embodiments, among exons described in database, peptide fragments detected in the stage after modification analysis in Step 104 that is not mapped and do not have any relationship will be called “undetected exons”.

Hereinafter, three analytical methods by using an undetected exon will be described. The analytical methods 1 and 2 correspond to Step 108 in FIG. 3, and the analytical method 3 corresponds to Step 109 in FIG. 3. The analyses shown in analytical methods 1 to 3 may be preformed as selected as needed. Combination of multiple analyses improves the accuracy of analysis. For example, all analyses may be performed in the order of analytical methods 1, 2, and 3.

(Pretreatment)

First, base sequences on the hypothetical gene corresponding to an identified peak are marked. Because PMF analysis is based on the splicing patterns described in database, all base sequences are likely mapped in the exon region in this stage.

(Analytical Method 1)

As the first analytical method, for example, the difference in splicing pattern is studied. In the analytical method, the differences in splicing pattern include the case where there is error in the description in database.

In the method, it is judged whether the region predicted to be an intron is used for translation. Specifically, the amino acid sequences of the polypeptides hypothetically translated from the region between “A (adenine) G (guanine)/GT (thymine)” and “AG/terminal of closest exon” or “terminal of closest exon/GT” present in all regions predicted to be introns are determined, the mass of the fragments produced hypothetically by trypsin digestion of the amino acid sequences is predicted, and the mass is compared with the mass of unidentified peak. As a result, base sequence regions that have relationship with the unidentified peak are marked. If there is at least one base sequence region corresponding to the unidentified peak, the region is considered to have a possibility of being used for protein translation. If such base sequence regions are present in multiples, it is considered that the possibility of the intron region being used for translation is higher.

It is also possible to apply analysis during the comparison, taking into consideration the possibility of the modification described in the second embodiment. By applying the analytical operation in the region, it becomes possible to use it in analysis even when there is an error in the exon-intron structure described in database. The base sequence of the intron boundary is normally GT-AG, but some genes are reported to have introns having 5′-terminal and 3′-terminal sequences of AT and AC, and thus, the regions between “AC/AT” and “AC/terminal of closest exon” or “terminal of closest exon/AT” may be analyzed as needed similarly.

(Analytical Method 2)

As the second analytical method, for example, abnormal splicing is studied. In the method, the amino acid sequences of the polypeptide hypothetically translated in three reading frames from all undetected exon and intron regions are determined. The mass of the hypothetical peptide fragments obtained by tripsin digestion of the amino acid sequences are predicted, and the mass is compared with the mass of the unidentified peak. The base sequence regions corresponding to the unidentified peak are marked. If there is at least one base sequence region corresponding to the unidentified peak, the reading frame and the region may be used in abnormal splicing. If such base sequence regions are present in multiples, it is considered that the possibility of the reading frame and the region being used for abnormal translation is higher.

(Analytical Method 3)

As the third analytical method analyzes, for example, frameshift mutation is studied. The procedures of analyzing splicing abnormality are described in analytical methods 1 and 2, but it is possible to retrieve frameshift mutation by using a similar procedure.

Attention is given to exons containing the detected peptide fragment mapped. The amino acid sequences corresponding to the base sequences in the undetected regions are predicted in other two reading frames. The mass of the hypothetical peptide fragments hypothetically generated by trypsin digestion of the predicted amino acid sequence is predicted, and the mass is compared with the mass of the unidentified peak. If there is at least one fragment having the same mass, there is the possibility of frameshift mutation from the middle because of mutation of the base sequence. If there are such fragments observed in multiples, it is considered that the possibility of the frameshift mutation from the middle because of mutation of the base sequence is higher.

Also in the method, it is also possible to apply analysis during comparison, taking into consideration the possibility of the modification described above in a similar manner to analytical method 1.

The analytical results obtained by these procedures are classified into the following cases:

(1) The case where the detected peptide fragment cannot be considered a mutant,
(2) The case 1 where it can be considered to be a mutant, containing no frameshift mutation and by the detection of a new exon, and
(3) The case 2 where it can be considered a mutant, containing frameshift mutation.

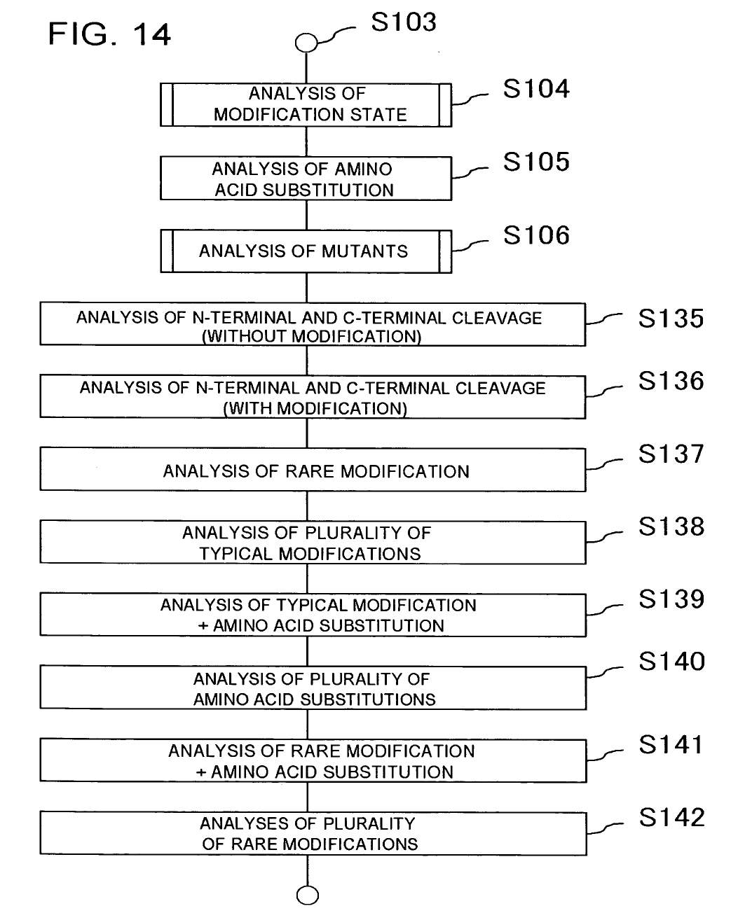

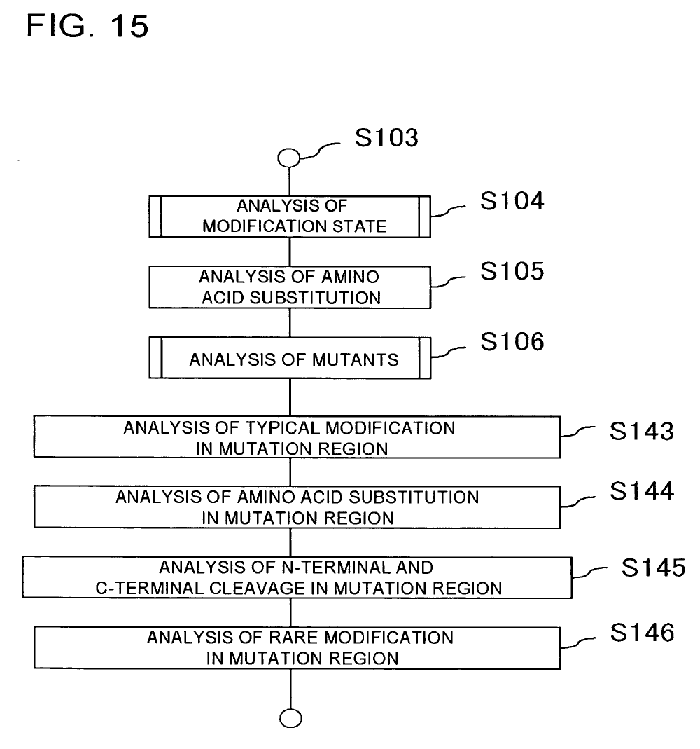

In the present embodiment, the subsequent analytical procedure is selected properly according to the results (1) to (3). FIGS. 14 and 15 are flow charts showing the procedure after the analysis of mutants in Step 106. If the result of (1) is obtained, the series of analyses shown in FIG. 14 are performed. Alternatively if the result of (2) or (3) is obtained, the series of analyses shown in FIGS. 14 and 15 are performed. The analysis shown in FIG. 14 is analysis using the frame registered in database, and even if the result (2) or (3) is obtained, it is necessary to verify the analysis because there is a region in which the frame is used.

In FIG. 14, the possibility of N-terminal and C-terminal cleavage when the terminal is unmodified is examined in Step 135. The possibility of N-terminal and C-terminal cleavage when the terminal is modified is examined in Step 136. The method of analyzing terminal cleavage will be described specifically in the fifth embodiment. The peaks remaining unidentified after analysis up into Step 106 are analyzed. If an N-terminal or C-terminal fragment is already detected, analysis of the detected terminal may not be performed.

Then, rare modification is analyzed (S137). As for the peaks remaining unidentified even in Step 106, a possibility of the rare modification shown in Tables 1 to 7 is analyzed. The method described in the second embodiment may be used for analysis. For indiscriminate retrieval of all candidates, the peaks remaining unidentified up into Step 104 may be used in analysis. In such a case, the processing in Step 137 may be performed at any time after Step 104.

Then, the case where there are both modification and amino acid substitution in multiples in the same fragment is analyzed (S138 to S142). The present embodiment will be described, taking a case where there are a total of two mutations, one modification and one amino acid substitution in the same fragment as an example.

The peaks remaining unidentified up into Step 137 are analyzed. For example, FIG. 14 shows a analytical procedure when the possibility of multiple modification and amino acid substitution is considered to be in the order from the highest of two typical modifications (S138)>one typical modification+one amino acid substitution (S139)>two amino acid substitution (S140)>one amino acid substitution+one rare modification (S141)>two rare modification (S142). In such a case, the analysis is performed in the order of the following analyses 1 to 5:

1. Analysis of the peaks remaining unidentified after analysis of up to Step 137 in S138,
2. Analysis in S139 for the peaks remaining unidentified,
3. Analysis in S140 for the peaks remaining unidentified,
4. Analysis in S141 for the peaks remaining unidentified, and
5. Analysis in S142 for the peaks remaining unidentified.

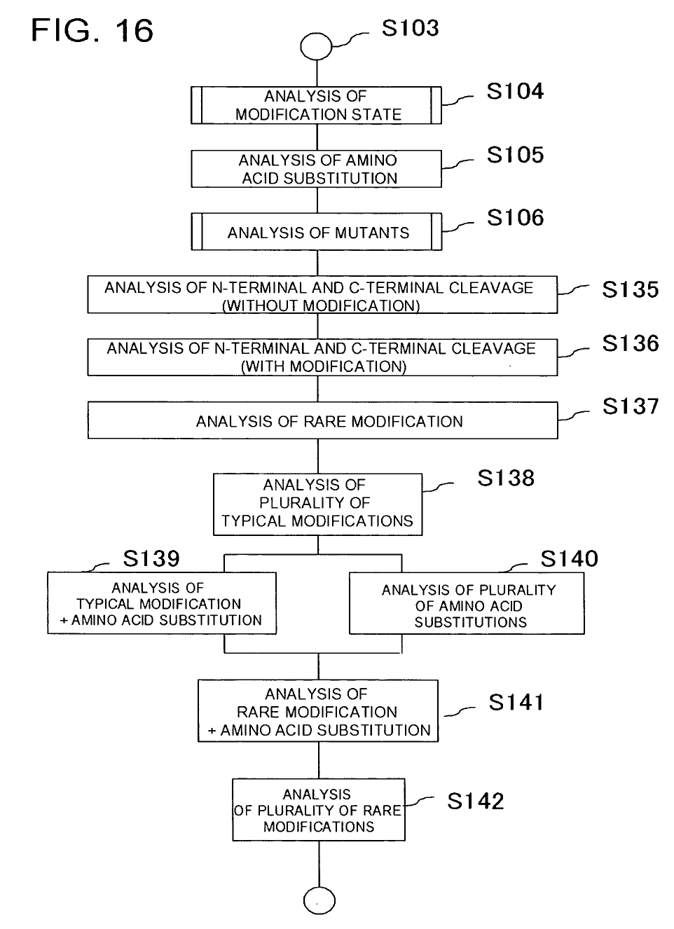

If the possibility of the prediction that there are plurality of modifications and amino acid substitutions is different, the order of the analyses of 1 to 5 may be changed according to the possibility for analysis. If the possibility is similar, the analyses may be performed not in series but in parallel. For example, if the probability of Step 139 and that of Step 140 are similar, the analysis may be performed in the order shown in FIG. 16. When the analysis is made in the procedure shown in FIG. 16, the analysis is performed by using unidentified peaks in the stage after analysis is performed up to Steps 139 and 140, in Step 141.

After the analysis of mutants in Step 106, the mutation region is analyzed (S143 to S146) in FIG. 15. In retrieval of translation products from the intron region and frameshift mutants in Step 106, the amino acid sequence corresponding to the base sequence region under study is predicted by referring to the base sequence of the hypothetical gene of the protein under study, and the mass of the trypsin-digested fragments is predicted and compared with the mass of the unidentified peak. Analysis similar to that in Steps 104, 105, 135, 136 and 137 is performed in Steps 143 to 146 in FIG. 15 during the comparison.

Typical modification in the mutation region is first analyzed (S143), amino acid substitution in the mutation region is then is analyzed (S144), N-terminal and C-terminal cleavage in the mutation region is then analyzed (S145); and rare modification in the mutation region is then analyzed (S146).

Any one of the methods in the embodiments above and in the fifth embodiment may be used in specific analysis in Steps 143 to 146.

### FIFTH EMBODIMENT

The present embodiment relates to the procedure of analyzing terminal cleavage (S107) in FIG. 2 in the analysis of unidentified peaks (S103) of FIG. 1. In the present embodiment, the peaks remaining unidentified after the analysis in Steps 101 to 104 are analyzed. If the trypsin-digested fragments at the N terminal or C terminal predicted from database are undetected in the stage after analysis of modification of side chain in Step 104, there is a possibility that they are undetected because they are partially cleaved after translation. In the present embodiment, the presence of such terminal cleavage and the kind and number of the cleaved amino acid residues are analyzed. The procedure in the present embodiment is preferably used when trypsin-digested fragments of both terminals have enough length to be ionized.

In the present embodiment, the amino acid sequence regions corresponding to the peptide fragments detected after hypothetical genes are identified by PMF analysis will be called “sequence regions covered by measured data”.

(Analysis of C-Terminal Cleavage)

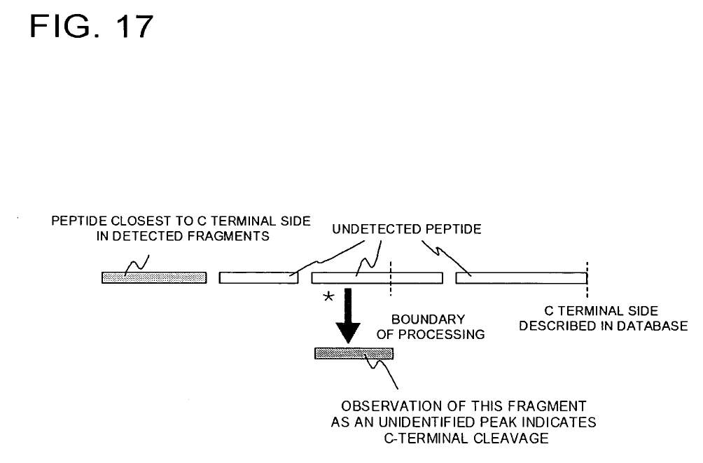

It is examined whether the actual C-terminal-containing fragment of sample protein is undetected because it becomes different in mass from the fragments predicted from database due to post-translational processing. Among the hypothetical peptide fragments generated from hypothetical amino acid sequence, it is analyzed whether the amino acid sequence after the detected fragment closest to the C terminal becomes undetected by post-translational cleavage of C terminal. FIG. 17 is a schematic chart showing the covering state of the trypsin-digested fragments predicted from database.

First among the peptide fragments detected in analysis in up to the Step 104, attention is given to undetected peptides after the fragment closest to the C terminal. The mass of the peptides when an amino acid residue is eliminated stepwise from the C terminal side of all undetected peptides under attention is calculated. It is then judged whether there is an unidentified peak having a mass identical with the mass corresponding to peptides obtained by the hypothetical processing, and the corresponding unidentified peak is extracted. The selected unidentified peak is a candidate for the actual C-terminal-containing unidentified peak.

If no candidate of unidentified peak is selected in the procedures above, the possibility that there is any modification in the C-terminal-containing fragments may be examined. Specifically, for example, with regard to a modification of interest shown in Table 8, the undetected peptides under attention after hypothetical processing that contain an amino acid residue that may be modified are selected first. The mass of the modified hypothetical fragment is calculated, by adding the mass difference associated with the selected modification to the mass calculated by hypothetical processing. It is then screened whether there is such a modification group-containing unidentified peak. The selected unidentified peak corresponds to an actual C-terminal peptide containing modification.

After the procedure above, consistency verification by MS/MS measurement may be performed. To eliminate the possibility that the unidentified peak extracted by the procedure above is noise, MS/MS measurement of the unidentified peak is performed. The consistency between the undetected peptide under attention indicated by * in FIG. 17 and the unidentified peak is verified, and if the consistency is confirmed, it suggests the possibility of C-terminal cleavage more convincingly. A method of obtaining the partial amino acid sequence thereof by de novo sequencing and verifying the consistency thereof may be used in this stage.

When the analysis above suggests C-terminal side processing, it is possible to verify more reliably by performing sequencing of the C-terminal amino acid sequence.

(Analysis of N-Terminal Cleavage)

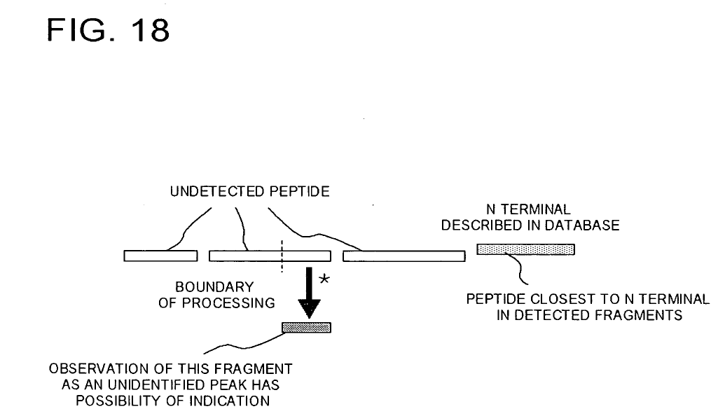

The possibility that the actual N-terminal-containing fragment of the sample protein becomes undetected by post-translational processing because the mass is different from the fragment predicted from database is examined. It is examined whether the amino acid sequence before the detected fragment closest to the N terminal (N-terminal-sided) among the hypothetical peptide fragments generated from hypothetical amino acid sequence becomes undetected by post-translational cleavage of N terminal. FIG. 18 is a schematic chart showing the covering state of the trypsin-digested fragments predicted from database.

First among the peptide fragments detected in analysis of up to Step 104, attention is given to all undetected peptides located at the N-terminal side of the fragment closest to the N terminal. The mass of the peptide fragments from all the undetected peptides under attention when an amino acid residue is cleaved stepwise from the N terminal thereof is calculated. It is then determined whether there is an unidentified peak having a mass identical with the mass corresponding to the hypothetical processing, and the corresponding unidentified peaks are extracted. The selected unidentified peak is a candidate of unidentified peak containing actual N-terminal.

If no candidate for unidentified peak is selected in the procedures above, the possibility of modification in the N-terminal-containing fragments similar to the modification in the case of C-terminal side fragments may be examined.

Following the procedure above, consistency verification by MS/MS measurement may be performed. To eliminate the possibility that the unidentified peak extracted by the procedure above is noise, MS/MS measurement of the unidentified peak is performed. The consistency between the undetected peptide under attention indicated by * in FIG. 18 and the unidentified peak is evaluated, and if the consistency is confirmed, it suggest the possibility of N-terminal side cleavage more convincingly. A method of obtaining the partial amino acid sequence thereof by de novo sequencing and verifying the consistency thereof may be used in this stage.

When the analysis above suggests N-terminal side processing, it is possible to verify more reliably by performing sequencing of the N-terminal amino acid sequence.

By using the method according to the present embodiment, it is possible to analyze whether cleavage of terminal peptide from the hypothetical amino acid sequence occurs in the analyte protein. It is possible to perform analysis reliably, because the N-terminal and C-terminal sides are then analyzed independently. When an analytical result indicating cleavage of terminal peptide is obtained, it is also possible to obtain information on the number of cleaved amino acid residues and the sequence structure additionally. Thus, it is possible to obtain information on more accurate primary structure of protein, which was not possible in conventional PMF analysis, at higher reliability.

The present invention is described so far with reference to embodiments. These embodiments are only examples of the present invention, and it should be understood for those skilled in the art that various modifications of the present invention are possible and these modifications are also included in the scope of the present invention.

For example, as for the oxidation reaction (c) and dehydration reaction (d) described above in the analysis of unidentified peaks of Step 103 there are amino acid substitution and modification accompanying the same mass difference. Table 12 is a table summarizing the amino acid substitutions and modifications accompanying the same mass difference as the oxidation or dehydration reaction. Also in Table 12, an amino acid residue is expressed with a single character.

TABLE 12

| | MODIFICATION | |
|---|---|---|
| | (CORRESPONDING | AMINO ACID |
| Δm | AMINO ACID RESIDUE) | SUBSTITUTION |
| 16 | hydroxylation | AS, SC, PL, VD, FY |
| | (of delta C of K, beta C of W, | [symbol] |
| | C3 or C4 of P, beta C of D) | |
| | 3,4-dihydroxy-phenylalanine | |
| | (from Y) | |
| | oxohistidine (from H) | |
| | sulfenic acid (from Y) | |
| 32 | 3,4-dihydroxylation (of P) | VM, AC, PE, DF, NC*₄, |
| | 3,4,6-trihydroxy-phenylalanine | [symbol] |
| | (from Y) | |
| −18 | formylglycine (from C) | DP, ML, MI, FE, |
| | pyroglutamic acid (from E) | [symbol] |
| | S-gamma-glutamyl (crosslinked to C) | |
| | O-gamma-glutamyl- (Crosslink to S) | |
| | alaninohistidine (S crosslinked to | |
| | theta or pi carbon of H) | |
| | succinimide formation (from D) | |

 MODIFICATIONS UNDERLINED OCCUR RARELY IN NATURAL PROTEINS.
 THE UNIT OF MASS DIFFERENCE Δm IS Da.

The change shown in Table 12 occurs only on a particular amino acid residue. Thus in Step 103 the amino acid sequences of the peptides corresponding to the peaks newly identified in the analysis (c) or (d) above are searched by using database. If corresponding amino acid residues are included, they are added as a possibility, and if not, they may be eliminated.

### Example

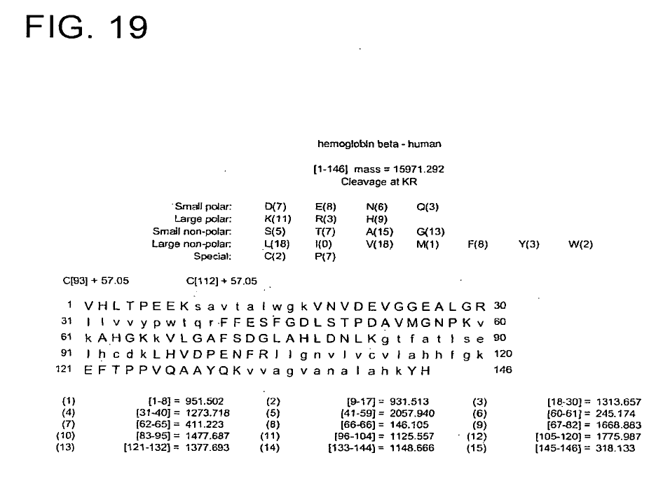

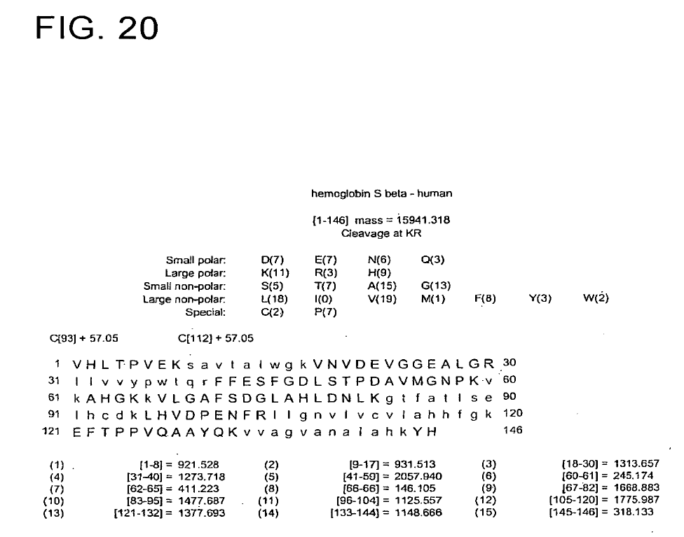

In the present Example, analysis of amino acid substitution was performed by using a mutant protein having a known amino acid sequence which contains amino acid substitution. The samples used were β-chain of human hemoglobin (sequence number 1) and β-chain of human hemoglobin S (sequence number 2). FIGS. 19 and 20 are tables respectively showing the amino acid sequence of human hemoglobin β-chain and human hemoglobin S β-chain and the mass of hypothetical peptide fragments predicted to be generated by trypsin digestion. FIGS. 19 and 20 show that these peptide chains are different from each other at the amino acid the sixth from the N terminal, i.e., E in hemoglobin or V in hemoglobin S. The difference will be observed as the mass difference between the first trypsin-digested fragments from N terminal side.

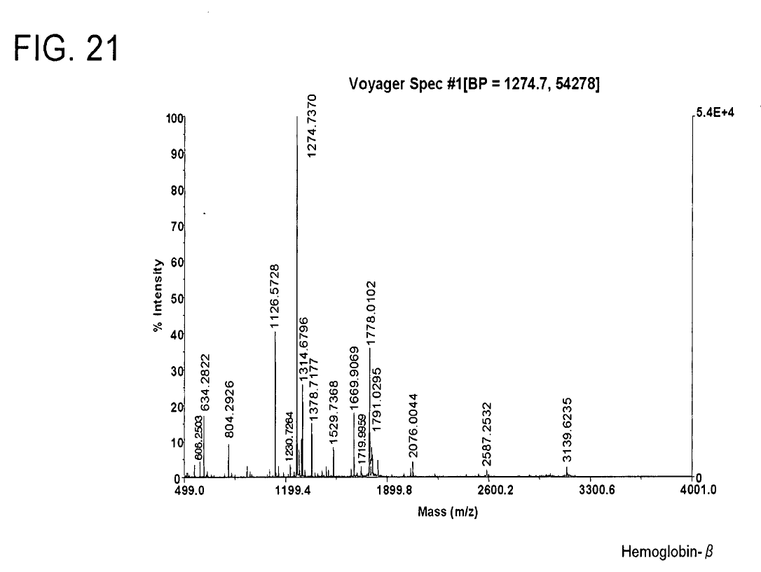

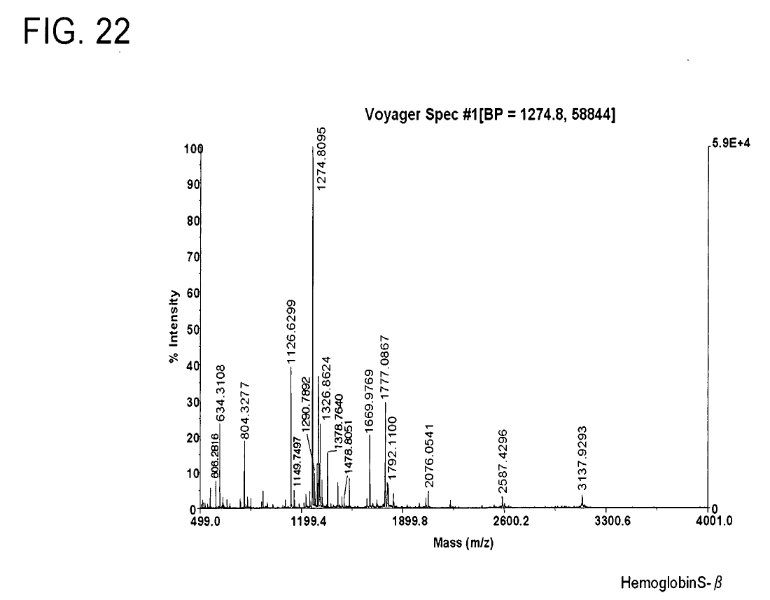

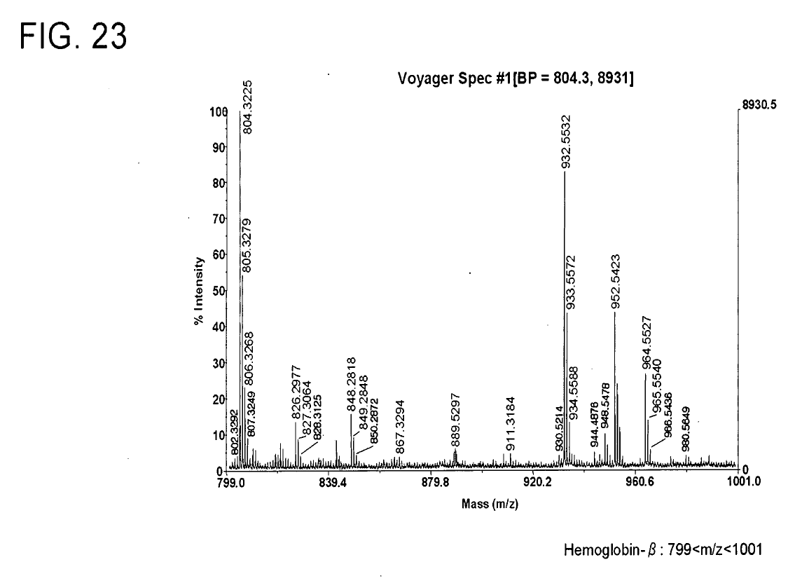

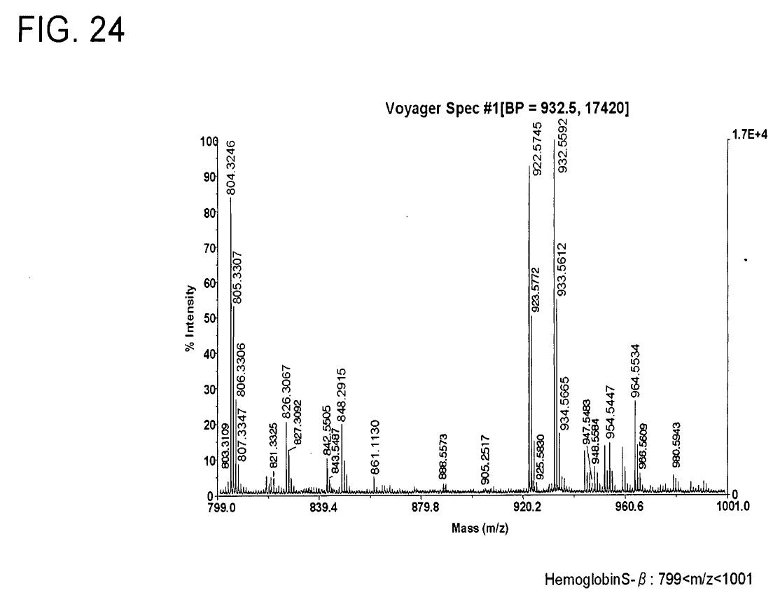

The mass spectrum of the protein was determined by MALDI-TOF-MS method. FIGS. 21 to 24 are graphs showing the mass spectra obtained. The abscissa axis in FIGS. 21 to 24 indicates mass to charge ratio (m/z), while the ordinate axis, intensity. FIG. 21 is a graph showing a mass spectrum of hemoglobin β-chain. FIG. 22 is a graph showing a mass spectrum of hemoglobin S β-chain. FIG. 23 is an expanded view of the mass spectrum of FIG. 21 in the region of 799<m/z<1001. FIG. 24 is an expanded view of the mass spectrum of FIG. 22 in the region of 799<m/z<1001.

Comparison of FIGS. 23 and 24 reveals that the peak of hemoglobin at an m/z of 952.5423 disappeared and the peak at an m/z of 922.5746 appeared newly in hemoglobin S. The mass difference Δm was −29.9677.

Examination in Table 10 on whether there is an amino acid substitution corresponding to the mass difference reveals that there is indeed a substitution from V to E in the column of d=Δm=30 in Table 10. As shown in Table 10, the single amino acid substitution corresponding to the mass difference not involving R or K is a substitution from M to T, from V to E, from T to A, or from S to G. Because there is no M or S contained in the amino acid sequence of the trypsin-digested fragments of the corresponding hemoglobin in the present Example, the possibility remains substitution from V to E or from T to A. In this case, the location of the substituted residue is also specified.

As described above, it was possible in the present Example to obtain analytical results suggesting a possibility of amino acid substitution by using unidentified peaks conventionally unused. In the present Example, there still remained two kinds of possibilities of substitution from V to E and from T to A, but it is possible to narrow the possibility only to substitution from V to E, by using the other analytical methods described above or performing analysis in combination with other information on the sample protein.

1. A method of analyzing a protein, comprising:
cleaving an analyte protein at a predetermined site selectively and obtaining the mass spectrum of the peptide fragments generated;
identifying the gene corresponding to said protein by using the peaks contained in said mass spectrum; and
analyzing at least one of the following (i) to (iv) by using unidentified peaks not corresponding to the hypothetical peaks, among said peaks, present in the hypothetical mass spectra of the hypothetical peptide fragments obtained by cleaving the hypothetical peptide predicted from said gene at the predetermined site above:
(i) modification of amino acid residue,
(ii) amino acid substitution,
(iii) change in gene expression pattern, and
(iv) cleavage of N-terminal-sided or C-terminal-sided amino acid residue.

2. The method of analyzing a protein according to claim 1,
wherein said unidentified peaks among said peaks and the undetected peptides not corresponding to said peaks present in said mass spectrum among said hypothetical peptide fragments are used in said performing at least one of the analyses (i) to (iv).

3. A method of analyzing a protein, comprising:
cleaving an analyte protein at a predetermined site selectively and obtaining the mass spectrum of the peptide fragments generated;
identifying the gene corresponding to said protein by using the peaks contained in said mass spectrum: and
analyzing the following (i), (ii), (iii), and (iv) by using unidentified peaks not corresponding to the hypothetical peaks present in the hypothetical mass spectra of the hypothetical peptide fragments obtained by cleaving the hypothetical peptide predicted from said gene at said predetermined site and the undetected peptides not corresponding to said peaks present in said mass spectrum among said hypothetical peptide fragments among the peaks:
(i) modification of amino acid residue,
(ii) amino acid substitution,
(iii) change in gene expression pattern, and
(iv) cleavage of N-terminal-sided or C-terminal-sided amino acid residue.

4. The method of analyzing a protein according to claim 1,
wherein said identifying the gene comprises:
extracting fragments containing a serine or threonine residue in their amino acid sequences from the undetected peptides not corresponding to said peaks present in said mass spectrum among said hypothetical peptide fragments; and
determining whether there are said unidentified peaks of said proteins having a mass corresponding to the mass of said extracted fragments when dehydrated, regarding the unidentified peaks, if present, as identified, and regarding the corresponding undetected peptides as detected fragments.

5. The method of analyzing a protein according to claim 1,
wherein said analyzing modification of amino acid residue (i) comprises:
determining the difference in mass between the undetected peptides not corresponding to said peaks present in said mass spectrum among said hypothetical peptide fragments and said unidentified peaks; and
comparing said difference with the increase in mass by modification of the amino acid residue in said proteins and judging that there is said modification if said difference is identical with said increase.

6. The method of analyzing a protein according to claim 1,
wherein said analyzing amino acid substitution (ii) comprises:
extracting said unidentified peak having a mass mex satisfying the Formula:
mth−151≦mex≦mth+151
with respect to the mass mth of the undetected peptide not corresponding to said peaks present in said mass spectrum among said hypothetical peptide fragments;
comparing the value mex−mth with the value of mass change that may occur by amino acid substitution and determining whether the value mex−mth is a value specific to said amino acid substitution; and
determining whether the amino acid residue corresponding to said amino acid substitution is included in said undetected peptide when said value mex−mth is a value specific to said amino acid substitution, and, if it is included, regarding that there is amino acid substitution.

7. The method of analyzing a protein according to claim 1,
wherein said analyzing amino acid substitution (ii) comprises:
extracting said unidentified peaks having a mass mex and a mass mex′ satisfying the following Formula (1) and the amino acid residues X at the cleavage site with respect to the mass mth of the undetected peptide not corresponding to said peaks present in said mass spectrum among said hypothetical peptide fragments;
determining whether there is the amino acid residue Y corresponding to ΔmYX in the following Formula (1) in said undetected peptides; and
determining whether there are the unidentified peaks corresponding to the mass of the hypothetical peptide fragments predicted to be generated by said amino acid substitution in said mass spectrum of said protein and regarding, if present, that there is amino acid substitution:
mex+mex′−18=mth+ΔmYX (1)
(in Formula (1), ΔmYX represents the mass change when an amino acid residue Y not at the cleavage site is substituted with the amino acid residue X at the cleavage site; and plurality of the amino acid residues X different in kind may be present at the cleavage site).

8. The method of analyzing a protein according to claim 1,
wherein said analyzing amino acid substitution (ii) comprises:
extracting the unidentified peaks having a mass mex satisfying the following Formula (2) with respect said neighboring undetected peptides having a mass mth and a mass mth′ in the sequence of said hypothetical peptide, from the undetected peptides not corresponding to said peaks present in said mass spectrum among said hypothetical peptide fragments; and
determining whether the peaks corresponding to said undetected peptides having a mass mth and a mass mth′ are absent in said mass spectrum of said protein and regarding, if absent, that there is amino acid substitution:
mth+mth′−18=mex+ΔmYX (2)
(in Formula (2), ΔmYX represents the mass change when an amino acid residue Y not at the cleavage site is substituted with the amino acid residue X at the cleavage site; and the amino acid residue X at the cleavage site is restricted to be an amino acid residue at the boundary of two of said undetected peptides).

9. The method of analyzing a protein according to claim 1,
wherein said analyzing the change in gene expression pattern (iii) comprises:
determining the hypothetical amino acid sequence of the hypothetical peptide hypothetically translated from the region between AG and GT, the region between AG and the terminal of the closest exon, the region between the terminal of the closest exon and GT among all regions in said gene predicted as introns; and
comparing the mass of the fragments of the hypothetical amino acid sequence when it is hypothetically trypsin-digested with the mass of said unidentified peak and regarding, if they are identical with each other, that there is splicing mutation.

10. The method of analyzing a protein according to claim 1,
wherein said analyzing the change in gene expression pattern (iii) comprises:
determining the amino acid sequence of the polypeptide hypothetically translated in three reading frames from all undetected exons and introns; and
determining whether the mass of said hypothetical peptide fragments obtained by trypsin digestion of said polypeptides are identical with the mass of said unidentified peaks and regarding, if they are identical with each other, that there is splicing mutation.

11. The method of analyzing a protein according to claim 1,
wherein said analyzing the change in gene expression pattern (iii) comprises
comparing the mass of the hypothetical peptide fragments obtained by hypothetical trypsin digestion of the peptides having an amino acid sequence predicted to be generated when the base sequence of the undetected regions in the exons containing the region coding the amino acid sequence of the detected peptide is translated while the reading frame is shifted by one or two bases with the mass of unidentified peaks and regarding, if there are some identical with each other, that there is frameshift mutation.

12. The method of analyzing a protein according to claim 1,
wherein said analyzing the cleavage of N-terminal-sided or C-terminal-sided amino acid residue (iv) comprises:
calculating the mass of the undetected peptide locating closer to the C terminal than the detected peptide closest to the C terminal among said undetected peptides not corresponding to said peaks present in the mass spectrum, when an amino acid residue is cleaved stepwise from the C-terminal side; and
determining whether an unidentified peak having a mass identical with the mass of said peptide is present in said mass spectrum and regarding, if present, that there is cleavage of the C-terminal-sided amino acid residue.

13. The method of analyzing a protein according to claim 1,
wherein said analyzing the cleavage of N-terminal-sided or C-terminal-sided amino acid residue (iv) comprises:
calculating the mass of the peptides obtained when the undetected peptide locating closer to the N terminal than the detected peptide closest to the N terminal among the undetected peptides not corresponding to said peaks present in said mass spectrum when an amino acid residue is cleaved stepwise from the N terminal side, and
determining whether there are unidentified peaks having a mass identical with the mass of said peptide in said mass spectrum and regarding, if present, that there is cleavage of N-terminal-sided amino acid residue.


SEQUENCE LISTING (2 sequences)

SEQ ID NO: 1 - protein, 146 aa, Homo sapiens
VHLTPEEKSAVTALWGKVNVDEVGGEALGRLLVVYPWTQRFFESFGDLSTPDAVMGNPKVKAHGKKVLGAFSDGLAHLDNLKGTFATLSELHCDKLHVDPENFRLLGNVLVCVLAHHFGKEFTPPVQAAYQKVVAGVANALAHKYH

SEQ ID NO: 2 - protein, 146 aa, Homo sapiens
VHLTPVEKSAVTALWGKVNVDEVGGEALGRLLVVYPWTQRFFESFGDLSTPDAVMGNPKVKAHGKKVLGAFSDGLAHLDNLKGTFATLSELHCDKLHVDPENFRLLGNVLVCVLAHHFGKEFTPPVQAAYQKVVAGVANALAHKYH